(19) United States
(12) Patent Application Publication
(10) Pub. No.: US 2010/0092672 A1
(43) Pub. Date: Apr. 15, 2010

(54) INKJET RECORDING METHOD

(75) Inventors: Hiroshi KAWAKAMI, Shizuoka-ken (JP); Wataru ONO, Shizuoka-ken (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/573,893

(22) Filed: Oct. 6, 2009

(30) Foreign Application Priority Data
Oct. 14, 2008 (JP) 2008-265570

(51) Int. Cl. B05D 5/00

(52) U.S. Cl. 427/256

(57) ABSTRACT

An inkjet recording method including recording on an inkjet recording medium having an ink receiving layer containing inorganic microparticles, a water-soluble resin and a crosslinking agent on a support, using an inkjet ink containing at least a dye, water, a diglycerin derivative of formula (1) and a water-soluble organic solvent, wherein 40% by weight or more of the water-soluble organic solvent is a water-soluble organic solvent which gives a swelling ratio of 3% or less for the water-soluble resin that has been crosslinked by the crosslinking agent.

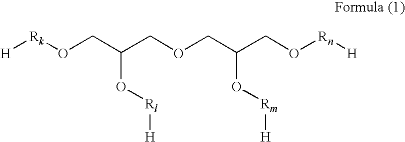

(wherein R represents an alkyleneoxy group having 2 to 5 carbon atoms; k, l, m and n each represent an integer indicating the number of repetition of the alkyleneoxy group; and k+l+m+n=0 to 50.)

### CROSS-REFERENCE TO RELATED APPLICATION

This application claims priority under 35 USC 119 from Japanese Patent Application No. 2008-265570 filed on Oct. 14, 2008, the disclosure of which is incorporated by reference herein.

### BACKGROUND OF THE INVENTION

1. Field of the Invention

The present invention relates to an inkjet recording method.

2. Description of the Related Art

Along with the rapid development of information technology industries in recent years, various information processing systems have been developed, and at the same time, recording methods and recording apparatuses that are pertinent to the respective information processing systems are also being put to practical use. Among these, inkjet recording methods have been widely used because of the advantages in that recording is possible on various materials to be recorded, that the hardware (apparatus) is relatively inexpensive and compact, and that the methods are excellent in quietness. Furthermore, in recording performed using an inkjet recording method, it is even possible to obtain so-called photograph-like high-quality recorded matter.

In recent years, recording media in which an ink receiving layer has a porous structure are being increasingly put to practical use. It is described that these recording media have excellent rapid-drying properties and give high glossiness.

However, the demand for high image quality is increasing more and more, and therefore, an inkjet recording medium capable of producing even clearer high-quality images (with high density) and also having excellent storability, is desired.

As for printing methods for obtaining high-density images, for example, Japanese Patent Application Laid-Open (JP-A) No. 2000-247022 and JP-A No. 2006-181954 disclose methods for obtaining high-density recorded images by regulating the pore size of the ink receiving layer.

However, both references, disclose only the pore size of the ink receiving layer before performing a printing process, and there is no description regarding a recording method of controlling the pore size of the ink receiving layer after a printing process.

Furthermore, various investigations to find other methods to obtain high-density images are also being conducted with respect to the inkjet ink. For example, JP-A No. 2005-336489 describes a method of obtaining printed images having high density by controlling the content or type of a water-soluble organic solvent contained in the ink.

As such, extensive investigations are being conducted with respect to inkjet recording methods capable of providing recorded images having high density. However, the demand with respect to image quality is increasing more and more in recent years, and image quality having higher density is demanded.

### SUMMARY OF THE INVENTION

The present invention has been made in view of the above circumstances and provides an inkjet recording method comprising performing recording on an inkjet recording medium having a support and an ink receiving layer containing at least inorganic microparticles, a water-soluble resin and a crosslinking agent provided on the support, using an inkjet ink containing at least a dye, water, a diglycerin derivative represented by the following formula (1) and a water-soluble organic solvent, wherein 40% by weight or more of the water-soluble organic solvent is a water-soluble organic solvent which gives a swelling ratio of 3% or less for the water-soluble resin that has been crosslinked by the crosslinking agent:

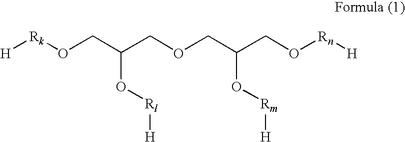

wherein R represents an alkyleneoxy group having 2 to 5 carbon atoms; k, l, m and n each represent an integer indicating the number of repetition of the alkyleneoxy group; and k+l+m+n=0 to 50.

### DETAILED DESCRIPTION OF THE INVENTION

In addition to the performance regarding the image quality, there has been a problem in that color starts to change immediately after printing and changes over time, which is characteristic to the inkjet recording method, and thus considerable time is taken until a stable printed image is obtained. There has been another problem in that ejection is unstable, and image irregularities occur in the recorded images.

The invention has an object of providing an inkjet recording method which is capable of obtaining sharp and high-density recorded images, is capable of highly suppressing color changes occurring from immediately after printing, and is excellent in ejection stability.

The inventors of the invention have earnestly conducted investigation of the problems described above, and as a result, they have found that when recording (printing) is performed using an inkjet ink containing a specific diglycerin derivative and a specific amount of a specific water-soluble organic solvent, not only may sharp and high-density recorded images be obtained, but also color changes occurring from immediately after printing are markedly suppressed, while a significant ameliorative effect on ejection stability is also obtained.

The objects of the invention described above have been solved by an inkjet recording method comprising performing recording on an inkjet recording medium having a support and an ink receiving layer containing at least inorganic microparticles, a water-soluble resin and a crosslinking agent provided on the support, using an inkjet ink containing at least a dye, water, a diglycerin derivative represented by the following formula (1) and a water-soluble organic solvent, wherein 40% by weight or more of the water-soluble organic solvent is a water-soluble organic solvent which gives a swelling ratio of 3% or less for the water-soluble resin that has been crosslinked by the crosslinking agent.

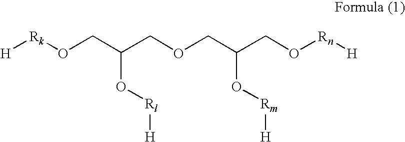

In formula (1), R represents an alkyleneoxy group having 2 to 5 carbon atoms; k, l, m and n each represent an integer indicating the number of repetition of the alkyleneoxy group; and k+l+m+n=0 to 50.

Preferably, the total content of the water-soluble organic solvent is 5% by weight to 25% by weight relative to the total weight of the inkjet ink.

Preferably, the content of the diglycerin derivative represented by formula (1) is 2% by weight to 15% by weight relative to the total weight of the inkjet ink.

Preferably, the water-soluble organic solvent which gives the swelling ratio of 3% or less is at least one selected from the group consisting of 1,2-alkanediol, ethylene glycol monoalkyl ether, diethylene glycol monoalkyl ether, propylene glycol monoalkyl ether, dipropylene glycol monoalkyl ether, ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether.

Preferably, the content of the water-soluble organic solvent which gives the swelling ratio of 3% or less is 60% by weight or more relative to the water-soluble organic solvent.

Preferably, the total content of the water-soluble organic solvent is 5% by weight to 25% by weight relative to the total weight of the inkjet ink, and the content of the diglycerin derivative represented by formula (1) is 2% by weight to 15% by weight relative to the total weight of the inkjet ink.

Preferably, the total content of the water-soluble organic solvent is 5% by weight to 25% by weight relative to the total weight of the inkjet ink, the content of the diglycerin derivative represented by formula (1) is 2% by weight to 15% by weight relative to the total weight of the inkjet ink, and the content of the water-soluble organic solvent which gives the swelling ratio of 3% or less is 60% by weight or more relative to the water-soluble organic solvent.

The invention can provide an inkjet recording method which is capable of obtaining sharp and high-density recorded images, is capable of highly suppressing color changes occurring from immediately after printing, and is excellent in ejection stability.

Hereinafter, the inkjet recording method of the invention will be described in detail.

The inkjet recording method of the invention includes performing recording on an inkjet recording medium having a support and an ink receiving layer containing at least inorganic microparticles, a water-soluble resin and a crosslinking agent provided on the support, using an inkjet ink containing at least a dye, water, a diglycerin derivative represented by formula (1) and a water-soluble organic solvent, wherein 40% by weight or more of the water-soluble organic solvent includes a water-soluble organic solvent which gives a swelling ratio of 3% or less for the water-soluble resin that has been crosslinked by the crosslinking agent.

According to the inkjet recording method of the invention, an inkjet recording method is provided which is capable of obtaining sharp and high-density recorded images, is capable of highly suppressing color changes occurring from immediately after printing, and is excellent in ejection stability.

<Inkjet Ink>

The inkjet ink related to the invention contains at least a dye, water and a water-soluble organic solvent, and may further contain other components, if necessary. The inkjet ink of the invention may be at least one selected from the group consisting of a yellow ink, a magenta ink, a cyan ink and a black ink, or may be composed of an ink set combining these inks. Hereinafter, each of the components contained in the inkjet ink related to the invention will be explained.

<Diglycerin Derivative>

The inkjet ink according to the invention contains at least one diglycerin derivative represented by the following formula (1) (hereinafter, also simply referred to as “diglycerin derivative”).

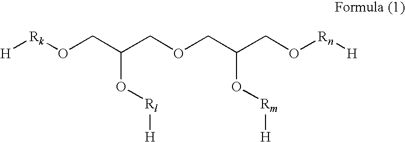

In formula (1), R represents an alkyleneoxy group having 2 to 5 carbon atoms; k, l, m and n each represent an integer indicating the number of repetition of the alkyleneoxy group; and k+l+m+n=0 to 50.

In formula (1), R represents an alkyleneoxy group having 2 to 5 carbon atoms. From the viewpoint of ejection stability, R is preferably an alkyleneoxy group having 2 to 4 carbon atoms, and more preferably an alkyleneoxy group having 2 or 3 carbon atoms.

Also, k, l, m and n each represent an integer representing the number of repetition of the alkyleneoxy group, and the sum total of k to n (k+l+m+n) is from 0 to 50. From the viewpoint of ejection stability, the sum total of k to n is preferably from 4 to 40.

According to the invention, the sum total of k to n being 0 means that the diglycerin derivative represented by formula (1) is diglycerin. In the diglycerin derivative represented by formula (1), the sum total of k to n being 1 means that the compound is a diglycerin derivative in which a hydrogen atom from any one of the four hydroxyl groups of diglycerin is removed, and a hydroxyalkyl group is substituted for the hydrogen atom. The sum total of k to n being 2 means that the compound is a diglycerin derivative in which two hydrogen atoms from any two of the four hydroxyl groups of diglycerin are removed, and a hydroxyalkyl group is substituted for each of the hydrogen atoms, or that the compound is a diglycerin derivative in which a hydrogen from any one of the four hydroxyl groups of diglycerin is removed, and a hydroxyalkyloxyalkyl group is substituted for the hydrogen atom.

The diglycerin derivative represented by formula (1) according to the invention is preferably a diglycerin derivative represented by the following formula (1a).

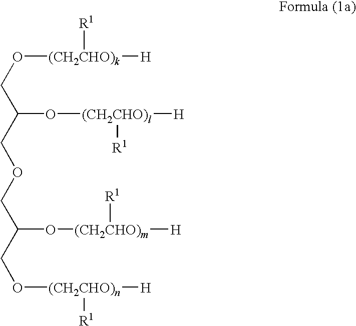

In formula (1a), R¹ represents a hydrogen atom or an alkyl group having 1 to 3 carbon atoms; k, l, m and n each represent an integer representing the number of repetition; and k+l+m+n=0 to 50.

According to the invention, from the viewpoint of ejection stability, R¹ is preferably a hydrogen atom or a methyl group, and the sum of k+l+m+n is preferably 4 to 40.

Among the diglycerin derivatives represented by formula (1), a diglycerin derivative in which the sum total of k to n is 1 or more may be produced by, for example, adding alkylene oxide to the hydroxyl group of diglycerin. The position at which alkylene oxide is added is not particularly limited, and alkylene oxide may be added to all of the four hydroxyl groups of diglycerin, or may be partially added to the hydroxyl groups.

Specific examples of the diglycerin derivative represented by formula (1) include diglycerin, polyoxypropylene diglyceryl ether (SC-P series) and polyoxyethylene diglyceryl ether (SC-E series) manufactured by Sakamoto Yakuhin Kogyo Co., Ltd., and the like.

The content of the diglycerin derivative represented by formula (1) in the inkjet ink of the invention is not particularly limited, but from the viewpoint of ejection stability, the content is preferably 25% by weight or less, more preferably 2% by weight to 15% by weight, and particularly preferably 4% by weight to 12% by weight.

According to the invention, the diglycerin derivatives represented by formula (1) may be used alone, or in a combination of two or more species.

In the diglycerin derivative represented by formula (1) according to the invention, it is preferable from the viewpoint of ejection stability that R be an alkyleneoxy group having 2 or 3 carbon atoms, the sum total of k, l, m and n be from 4 to 40, and the content of the diglycerin derivative in the inkjet ink be 2% by weight to 15% by weight.

—Water-Soluble Organic Solvent—

The inkjet ink related to the invention contains a water-soluble organic solvent. According to the invention, it is required that 40% by weight or more of the water-soluble organic solvent contained in the inkjet ink is a water-soluble organic solvent (hereinafter, also referred to as a specific water-soluble organic solvent) which gives a swelling ratio of 3% or less for the water-soluble resin that has been crosslinked by a crosslinking agent and is included in the ink receiving layer to be described later.

Here, the “water-soluble organic solvent which gives a swelling ratio of 3% or less for the water-soluble resin that has been crosslinked by a crosslinking agent” will be explained.

The “crosslinking agent” and “water-soluble resin” in regard to the specific water-soluble organic solvent respectively mean the crosslinking agent and water-soluble resin that are included in the ink receiving layer, which constitutes the inkjet recording medium that will be described later. The swelling ratio of a water-soluble resin that has been crosslinked by a crosslinking agent represents the swelling ratio obtainable when 1 mL of a water-soluble organic solvent contained in the ink that will be used in recording, is added dropwise onto a film of the water-soluble resin that has been crosslinked by the crosslinking agent, and the film is allowed to stand for 5 minutes. The swelling ratio may be determined by the following expression.

(Swelling ratio, %)=(increase in the film thickness due to the dropwise addition of the water-soluble organic solvent)/(film thickness before the dropwise addition of the water-soluble organic solvent)×100

The ratio of the amount of crosslinking agent to the amount of the water-soluble resin in the water-soluble resin film supplied to the measurement of the swelling ratio, is required to be made consistent with the ratio of amount of the crosslinking agent to the amount of water-soluble resin in the ink receiving layer that is actually subjected to printing, in order to bring about a more strict correspondence with respect to the density or the performance such as the color changes occurring from immediately after printing. The thickness of the water-soluble resin film needs to be adjusted to 5 μm to 10 μm. The measurement of the swelling ratio is carried out under an environment of 23° C. and 50% RH. In the measurement of the swelling ratio, a water-soluble resin film that has been conditioned under an environment of 23° C. and 50% RH for at least 24 hours is used.

If the content of the specific water-soluble organic solvent in the water-soluble organic solvents contained in the inkjet ink is less than 40% by weight, sufficient performance may not be obtained with regard to the print density or the color changes occurring from immediately after printing.

As for the specific water-soluble organic solvent, above all, a water-soluble organic solvent which gives a swelling ratio of 2% or less for a water-soluble resin that has been crosslinked by the crosslinking agent is more preferable; a water-soluble organic solvent which gives the swelling ratio of 1% or less is even more preferable; and a water-soluble organic solvent which gives the swelling ratio of 0.5% or less is particularly preferable. The content of the specific water-soluble organic solvent is more preferably 60% by weight or more, even more preferably 80% by weight or more, and particularly preferably 90% by weight or more, based on the total amount of water-soluble organic solvent contained in the inkjet ink. When an inkjet ink containing a specific amount of the specific water-soluble organic solvent as described above is used, inkjet recorded images having high image densities and suppressed color changes after printing may be obtained.

As for the specific water-soluble organic solvent, a solvent which results in a swelling ratio of 3% or less for a water-soluble resin that has been crosslinked by a crosslinking agent may be selected from among water-soluble organic solvents, and used.

Specific examples of the water-soluble organic solvents include alcohols (for example, methanol, ethanol, propanol, isopropanol, butanol, isobutanol, sec-butanol, t-butanol, pentanol, hexanol, cyclohexanol, and benzyl alcohol); polyhydric alcohols (for example, ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thiodiglycol); glycol derivatives (for example, ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, propylene glycol monoethyl ether, ethylene glycol dimethyl ether, diethylene glycol dimethyl ether, triethylene glycol dimethyl ether, propylene glycol dimethyl ether, dipropylene glycol dimethyl ether, tripropylene glycol dimethyl ether, ethylene glycol diacetate, ethylene glycol monomethyl ether acetate, triethylene glycol monomethyl ether, triethylene glycol monoethyl ether, and ethylene glycol monophenyl ether); amines (for example, ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine, and tetramethylpropylenediamine); and other polar solvents (for example, formamide, N,N-dimethylformamide, N,N-dimethylacetamide, dimethylsulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile, and acetone).

The water-soluble organic solvents may be used alone, or in a combination of two or more species.

Here, the “water-soluble organic solvent” according to the invention refers to an organic solvent which, when mixed with water, does not undergo phase separation and is compatible with water.

The total content of the water-soluble organic solvent in the inkjet ink in the invention is preferably 5% by weight to 70% by weight, more preferably 5% by weight to 50% by weight, even more preferably 5% by weight to 40% by weight, and particularly preferably 5% by weight to 25% by weight.

In the case where the water-soluble resin included in the ink receiving layer that will be described later is, for example, a polyvinyl alcohol, the specific water-soluble organic solvent is preferably at least one selected from the group consisting of 1,2-alkanediol, ethylene glycol monoalkyl ether, diethylene glycol monoalkyl ether, propylene glycol monoalkyl ether, dipropylene glycol monoalkyl ether, ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether.

The 1,2-alkanediol is preferably an alkanediol having an alkylene group having 2 to 6 carbon atoms, and even more preferably, ethylene glycol or 1,2-propanediol from the viewpoint of print density.

The ethylene glycol monoalkyl ether, diethylene glycol monoalkyl ether, propylene glycol monoalkyl ether and dipropylene glycol monoalkyl ether each preferably have an alkyl group having 1 to 5 carbon atoms, and more preferably, are each a monomethyl ether, a monoethyl ether or a monobutyl ether from the viewpoint of print density.

The ethylene glycol dialkyl ether, diethylene glycol dialkyl ether, triethylene glycol dialkyl ether, propylene glycol dialkyl ether, dipropylene glycol dialkyl ether and tripropylene glycol dialkyl ether each preferably have an alkyl group having 1 to 3 carbon atoms from the viewpoint of high print density without impairing the solubility in the ink liquid, and more preferably are each a dimethyl ether.

Even among the water-soluble organic solvents mentioned above, ethylene glycol monomethyl ether, ethylene glycol monoethyl ether, ethylene glycol monobutyl ether, propylene glycol monomethyl ether, propylene glycol monoethyl ether, propylene glycol monobutyl ether, ethylene glycol dimethyl ether, diethylene glycol dimethyl ether, triethylene glycol dimethyl ether, propylene glycol dimethyl ether, dipropylene glycol dimethyl ether, and tripropylene glycol dimethyl ether are particularly preferable, from the viewpoints of the image density and the suppression of the color changes after printing.

—Dye—

The inkjet ink related to the invention further contains at least one dye, in addition to the water-soluble organic solvent. General dyes that can be used for inkjet printing may be used. Examples thereof include dyes that are classified into acidic dyes, direct dyes, reactive dyes, vat dyes, sulfide dyes or food colorants in the Color Index, and in addition to these, dyes that are classified into oil-soluble dyes, basic dyes or the like may also be used.

Examples of the dye include an azo dye, an azomethine dye, a xanthene dye, a quinone dye and the like. Specific examples of dye will be shown below. However, the present invention is not limited to these exemplified compounds.

[C.I. Acid Yellow]

C.I. Acid Yellow Nos. 1, 3, 11, 17, 18, 19, 23, 25, 36, 38, 40, 42, 44, 49, 59, 61, 65, 67, 72, 73, 79, 99, 104, 110, 114, 116, 118, 121, 127, 129, 135, 137, 141, 143, 151, 155, 158, 159, 169, 176, 184, 193, 200, 204, 207, 215, 219, 220, 230, 232, 235, 241, 242, and 246

[C.I. Acid Orange]

### C.I. Acid Orange Nos. 3, 7, 8, 10, 19, 24, 51, 56, 67, 74, 80, 86, 87, 88, 89, 94, 95, 107, 108, 116, 122, 127, 140, 142, 144, 149, 152, 156, 162, 166, and 168

[C.I. Acid Red]

C.I. Acid Red Nos. 1, 6, 8, 9, 13, 18, 27, 35, 37, 52, 54, 57, 73, 88, 97, 106, 111, 114, 118, 119, 127, 131, 138, 143, 145, 151, 183, 195, 198, 211, 215, 217, 225, 226, 249, 251, 254, 256, 257, 260, 261, 265, 266, 274, 276, 277, 289, 296, 299, 315, 318, 336, 337, 357, 359, 361, 362, 364, 366, 399, 407, and 415

[C.I. Acid Violet]

### C.I. Acid Violet Nos. 17, 19, 21, 42, 43, 47, 48, 49, 54, 66, 78, 90, 97, 102, 109, and 126

[C.I. Acid Blue]

C.I. Acid Blue Nos. 1, 7, 9, 15, 23, 25, 40, 62, 72, 74, 80, 83, 90, 92, 103, 104, 112, 113, 114, 120, 127, 128, 129, 138, 140, 142, 156, 158, 171, 182, 185, 193, 199, 201, 203, 204, 205, 207, 209, 220, 221, 224, 225, 229, 230, 239, 249, 258, 260, 264, 278, 279, 280, 284, 290, 296, 298, 300, 317, 324, 333, 335, 338, 342, and 350

[C.I. Acid Green]

### C.I. Acid Green Nos. 9, 12, 16, 19, 20, 25, 27, 28, 40, 43, 56, 73, 81, 84, 104, 108, and 109

[C.I. Acid Brown]

### C.I. Acid Brown Nos. 2, 4, 13, 14, 19, 28, 44, 123, 224, 226, 227, 248, 282, 283, 289, 294, 297, 298, 301, 355, 357, and 413

[C.I. Acid Black]

### C.I. Acid Black Nos. 1, 2, 3, 24, 26, 31, 50, 52, 58, 60, 63, 107, 109, 112, 119, 132, 140, 155, 172, 187, 188, 194, 207, and 222

[C.I. Direct Yellow]

### C.I. Direct Yellow Nos. 8, 9, 10, 11, 12, 22, 27, 28, 39, 44, 50, 58, 79, 86, 87, 98, 105, 106, 130, 132, 137, 142, 147, and 153

[C.I. Direct Orange]

### C.I. Direct Orange Nos. 6, 26, 27, 34, 39, 40, 46, 102, 105, 107, and 118

[C.I. Direct Red]

### C.I. Direct Red Nos. 2, 4, 9, 23, 24, 31, 54, 62, 69, 79, 80, 81, 83, 84, 89, 95, 212, 224, 225, 226, 227, 239, 242, 243, and 254

[C.I. Direct Violet]

### C.I. Direct Violet Nos. 9, 35, 51, 66, 94, and 95

[C.I. Direct Blue]

### C.I. Direct Blue Nos. 1, 15, 71, 76, 77, 78, 80, 86, 87, 90, 98, 106, 108, 160, 168, 189, 192, 193, 199, 200, 201, 202, 203, 218, 225, 229, 237, 244, 248, 251, 270, 273, 274, 290, and 291

[C.I. Direct Green]

### C.I. Direct Green Nos. 26, 28, 59, 80, and 85

[C.I. Direct Brown]

### C.I. Direct Brown Nos. 44, 106, 115, 195, 209, 210, 222, and 223

[C.I. Direct Black]

### C.I. Direct Black Nos. 17, 19, 22, 32, 51, 62, 108, 112, 113, 117, 118, 132, 146, 154, 159, and 169

[C.I. Basic Yellow]

### C.I. Basic Yellow Nos. 1, 2, 11, 13, 15, 19, 21, 28, 29, 32, 36, 40, 41, 45, 51, 63, 67, 70, 73, and 91

[C.I. Basic Orange]

### C.I. Basic Orange Nos. 2, 21, and 22

[C.I. Basic Red]

### C.I. Basic Red Nos. 1, 2, 12, 13, 14, 15, 18, 23, 24, 27, 29, 35, 36, 39, 46, 51, 52, 69, 70, 73, 82, and 109

[C.I. Basic Violet]

### C.I. Basic Violet Nos. 1, 3, 7, 10, 11, 15, 16, 21, 27, and 39

[C.I. Basic Blue]

### C.I. Basic Blue Nos. 1, 3, 7, 9, 21, 22, 26, 41, 45, 47, 52, 54, 65, 69, 75, 77, 92, 100, 105, 117, 124, 129, 147, and 151

[C.I. Basic Green]

### C.I. Basic Green Nos. 1, and 4

[C.I. Basic Brown]

### C.I. Basic Brown No. 1

[C.I. Reactive Yellow]

### C.I. Reactive Yellow Nos. 2, 3, 7, 15, 17, 18, 22, 23, 24, 25, 27, 37, 39, 42, 57, 69, 76, 81, 84, 85, 86, 87, 92, 95, 102, 105, 111, 125, 135, 136, 137, 142, 143, 145, 151, 160, 161, 165, 167, 168, 175, and 176

[C.I. Reactive Orange]

### C.I. Reactive Orange Nos. 1, 4, 5, 7, 11, 12, 13, 15, 16, 20, 30, 35, 56, 64, 67, 69, 70, 72, 74, 82, 84, 86, 87, 91, 92, 93, 95, and 107

[C.I. Reactive Red]

C.I. Reactive Red Nos. 2, 3, 5, 8, 11, 21, 22, 23, 24, 28, 29, 31, 33, 35, 43, 45, 49, 55, 56, 58, 65, 66, 78, 83, 84, 106, 111, 112, 113, 114, 116, 120, 123, 124, 128, 130, 136, 141, 147, 158, 159, 171, 174, 180, 183, 184, 187, 190, 193, 194, 195, 198, 218, 220, 222, 223, 228, and 235

[C.I. Reactive Violet]

### C.I. Reactive Violet Nos. 1, 2, 4, 5, 6, 22, 23, 33, 36, and 38

[C.I. Reactive Blue]

C.I. Reactive Blue Nos. 2, 3, 4, 5, 7, 13, 14, 15, 19, 21, 25, 27, 28, 29, 38, 39, 41, 49, 50, 52, 63, 69, 71, 72, 77, 79, 89, 104, 109, 112, 113, 114, 116, 119, 120, 122, 137, 140, 143, 147, 160, 161, 162, 163, 168, 171, 176, 182, 184, 191, 194, 195, 198, 203, 204, 207, 209, 211, 214, 220, 221, 222, 231, 235, and 236

[C.I. Reactive Green]

### C.I. Reactive Green Nos. 8, 12, 15, 19, and 21

[C.I. Reactive Brown]

### C.I. Reactive Brown Nos. 2, 7, 9, 10, 11, 17, 18, 19, 21, 23, 31, 37, 43, and 46

[C.I. Reactive Black]

### C.I. Reactive Black Nos. 5, 8, 13, 14, 31, 34, and 39

[C.I. Food Black]

### C.I. Food Black Nos. 1 and 2

The magenta dye, cyan dye, black dye and yellow dye that may be used in the inkjet ink related to the invention are preferably those dyes shown below.

Specifically, examples of the magenta dye that may be used in the inkjet ink in the invention include aryl or heterylazo dyes including, for example, phenols, naphthols, anilines or the like as a coupler component; azomethine dyes including, for example, pyrazolones, pyrazolotriazoles or the like as a coupler component; methine dyes such as arylidene dyes, styryl dyes, merocyanine dyes, cyanine dyes or oxonol dyes; carbonium dyes such as diphenylmethane dyes, triphenylmethane dyes or xanthene dyes; quinone dyes such as naphthoquinones, anthraquinones or anthrapyridones; condensed polycyclic dyes such as dioxazine dyes; and the like. However, the present invention is not limited to these exemplified compounds.

The magenta dye is preferably heterocyclic azo dyes. Those dyes described in WO 2002/83795 (pages 35 to 55), WO 2002/83662 (pages 27-42), JP-A No. 2004-149560 (paragraphs [0046] to [0059]), JP-A No. 2004-149561 (paragraphs [0047] to [0060]), and JP-A No. 2007-70573 (paragraphs [0073] to [0082]) are more preferable from the viewpoint of ozone resistance.

Examples of the cyan dye that may be used in the inkjet ink in the invention include aryl or heterylazo dyes including, for example, phenols, naphthols, anilines or the like as a coupler component; azomethine dyes including, for example, phenols, naphthols, heterocyclic rings such as pyrrolotriazoles, or the like as a coupler component; polymethine dyes such as cyanine dyes, oxonol dyes or merocyanine dyes; carbonium dyes such as diphenylmethane dyes, triphenylmethane dyes or xanthene dyes; phthalocyanine dyes; anthraquinone dyes; indigo/thioindigo dyes; and the like. However, the present invention is not limited to these exemplified compounds.

Associative phthalocyanine dyes are preferable, and those dyes described in WO 2002/60994, WO 2003/00811, WO 2003/62324, JP-A Nos. 2003-213167, 2004-75986, 2004-323605, 2004-315758, 2004-315807, 2005-179469, and 2007-70573 (paragraphs [0083] to [0090]) are more preferable from the viewpoint of ozone resistance.

Examples of the black dye that may be used in the inkjet ink in the invention include disazo dyes, trisazo dyes, and tetrakisazo dyes. These black dyes may also be used in combination with a pigment such as a dispersion of carbon black.

Preferable examples of the black dye having excellent ozone resistance are described in detail in JP-A No. 2005-307177, and JP-A No. 2006-282795 (paragraphs [0068] to [0087]).

Examples of the yellow dye that may be used in the inkjet ink in the invention include those dyes described in WO 2005/075573, JP-A No. 2004-83903 (paragraphs [0024] to [0062]), JP-A No. 2003-277661 (paragraphs [0021] to [0050]), JP-A No. 2003-277262 (paragraphs [0042] to [0047]), JP-A No. 2003-128953 (paragraphs [0025] to [0076]), JP-A No. 2003-41160 (paragraphs [0028] to [0064]), and U.S. Patent Application Publication No. 2003/0213405 (paragraph [0108]); and C.I. Direct Yellow Nos. 8, 9, 11, 12, 27, 28, 29, 33, 35, 39, 41, 44, 50, 53, 59, 68, 86, 87, 93, 95, 96, 98, 100, 106, 108, 109, 110, 130, 132, 142, 144, 161 and 163; C.I. Acid Yellow Nos. 17, 19, 23, 25, 39, 40, 42, 44, 49, 50, 61, 64, 76, 79, 110, 127, 135, 143, 151, 159, 169, 174, 190, 195, 196, 197, 199, 218, 219, 222 and 227; C.I. Reactive Yellow Nos. 2, 3, 13, 14, 15, 17, 18, 23, 24, 25, 26, 27, 29, 35, 37, 41 and 42; C.I. Basic Yellow Nos. 1, 2, 4, 11, 13, 14, 15, 19, 21, 23, 24, 25, 28, 29, 32, 36, 39 and 40; and the like. The yellow dyes described in JP-A No. 2007-191650, paragraphs [0013] to [0112] and [0114] to [0121] are also preferable from the viewpoint of ozone resistance.

The dye used in the inkjet ink in the invention is preferably a water-soluble dye. The water-soluble dye is not particularly limited, and is appropriately selected while the color tone or the like required for the inkjet ink is taken into consideration. A water-soluble dye refers to a dye which dissolves in an amount of 0.2 g or more in 100 mL of water solvent (at 25° C.).

When the inkjet ink in the invention is at least one selected from the group consisting of a yellow ink, a magenta ink, a cyan ink and a black ink, the magenta dye and the cyan dye which are contained respectively in inkjet ink are all anionic water-soluble dyes, and the water-soluble group of the anionic water-soluble dyes is a sulfonic acid group, and may have an Li⁺ ion or a quaternary ammonium ion as a counterion.

In other words, according to the invention, the water-soluble group of the anionic water-soluble dye in the magenta ink and the cyan ink may be identified with a sulfonic acid group, and the counterion may be identified with an Li⁺ ion or a quaternary ammonium ion. The most preferable counterion is an Li⁺ ion.

Similarly, the yellow dye and the black dye contained in a yellow ink and a black ink, respectively, are all anionic water-soluble dyes, and the water-soluble group of the anionic water-soluble dyes is a sulfonic acid group, a carboxyl group or a phenolic hydroxyl group. When the water-soluble group is a sulfonic acid group, it is preferable to use an Li⁺ ion or a quaternary ammonium ion as the counterion, and when the water-soluble group is a carboxyl group or a phenolic hydroxyl group, it is preferable to use a K⁺ ion or an Na⁺ ion as the counterion.

A preferable combination is such that when the water-soluble group is a sulfonic acid group, the counterion is an Li⁺ ion. When the water-soluble group is a carboxyl group or a phenolic hydroxyl group, the counterion is preferably a K⁺ ion in order to give priority to the solubility of the dye in water, or the counterion is preferably an Na⁺ ion in order to give priority to the interaction with the dye having a sulfonic acid group. These are appropriately selected.

As such, there exists the optimal combination for the water-soluble group and the counterion, and since the preferable counterions for the sulfonic acid group and the carboxyl group are different from each other, it is preferable that the dye does not have a sulfonic acid group and a carboxyl group at the same time in the molecule.

The content of the dye contained in the inkjet ink in the invention is preferably 0.5% by weight to 30% by weight, and more preferably 1.0% by weight to 15% by weight. When the content is set at 0.5% by weight or more, the print density becomes satisfactory. Furthermore, when the content is set at 30% by weight or less, an increase in the viscosity of the inkjet ink or the occurrence of the structural viscosity in the viscosity characteristics may be suppressed, so that the ejection stability of the ink ejected from the inkjet head becomes satisfactory.

In addition to the components described above, for the purpose of enhancing the ejection stability of the inkjet ink used in the invention, the print quality, the durability of images or the like, additives such as a surfactant, or a drying preventing agent, a penetration promoting agent, a urea-based additive, a chelating agent, an ultraviolet absorbent, an antioxidant, a viscosity adjusting agent, a surface tension adjusting agent, a dispersant, a dispersion stabilizer, an antiseptic, an anti-mold agent, a corrosion inhibitor, a pH adjusting agent, antifoaming agent, a polymeric material, an acid precursor and the like, described in JP-A No. 2004-331871, may be appropriately selected and used. A preferable amount of use of these additives is as described in JP-A No. 2004-331871.

The viscosity at 20° C. of the inkjet ink used in the invention is preferably 2.0 mPa·s to 30 mPa·s from the viewpoint of ejectability. It is more preferable to adjust the viscosity to 2.5 mPa·s to 20 mPa·s, even more preferably to 3.0 mPa·s or more but less than 15 mPa·s, and still more preferably to 3.5 mPa·s or more but less than 12 mPa·s.

For the purpose of adjusting the viscosity as mentioned above, a viscosity adjusting agent may be used. Examples of the viscosity adjusting agent include celluloses, water-soluble polymers such as polyvinyl alcohol, nonionic surfactants, and the like. Further details on the viscosity adjusting agent are described in Chapter 9 of “Viscosity Adjustment Technology,” (Technical Information Institute Co., Ltd., 1999), and on pages 162 to 174 of “Chemicals for Inkjet Printers ('98 augmented edition)—Survey on Trend and Prospect of Material Development” (CMC Publishing Inc., 1997).

In regard to the viscosity, a value obtained by measuring an inkjet ink adjusted to a temperature of 20° C. using an oscillatory viscometer (trade name: DV-II+ VISCOMETER, manufactured by Brookfield Engineering Laboratories, Inc.), under an environment of 20° C. and at a relative humidity of 50%, using a cone-plate system (φ35 mm) while maintaining the ink in the form of an undiluted solution, is employed.

Preferable ranges or methods for measurement of ink physical properties such as the pH, electric conductivity, viscosity, static surface tension and dynamic surface tension of the inkjet ink, methods for controlling these properties, and the like are also as described in JP-A No. 2004-331871.

In regard to the method for preparing an inkjet ink, various processes are described in detail in JP-A Nos. 5-148436, 5-295312, 7-97541, 7-82515, 7-118584 and 2004-331871, and these methods may also be used for the preparation of the inkjet ink in the invention.

In the preparation of an inkjet ink, ultrasonic vibration may be applied at a dissolution process of additives such as dyes, and the like, as described in JP-A No. 2004-331871.

Upon preparing an inkjet ink, a process of eliminating solid wastes by filtration, which is carried out after preparing the liquid, is important. The filtration process is also as described in JP-A No. 2004-331871.

<Inkjet Recording Medium>

The inkjet recording medium in the invention includes, on a support, an ink receiving layer containing at least inorganic microparticles, a water-soluble resin and a crosslinking agent, and if necessary, may further includes other layers.

(Water-Soluble Resin)

The ink receiving layer in the invention contains a water-soluble resin.

The term “water-soluble resin” according to the invention refers to a resin which, after going through a heating or cooling process, finally dissolves in an amount of 0.05 g or more in 100 g of water at 20° C., and preferably 0.1 g or more.

Examples of the water-soluble resin include polyvinyl alcohol-based resins, which are resins having a hydroxyl group as a hydrophilic structural unit (polyvinyl alcohol (PVA), acetoacetyl-modified polyvinyl alcohol, cation-modified polyvinyl alcohol, anion-modified polyvinyl alcohol, silanol-modified polyvinyl alcohol, polyvinyl acetal, and the like), cellulose-based resins (methyl cellulose (MC), ethyl cellulose (EC), hydroxyethyl cellulose (HEC), carboxymethyl cellulose (CMC), hydroxypropyl cellulose (HPC), hydroxyethylmethyl cellulose, hydroxypropylmethyl cellulose, and the like), chitins, chitosans, starches, resins having an ether bonding (polyethylene oxide (PEO), polypropylene oxide (PPO), polyethylene glycol (PEG), polyvinyl ether (PVE), and the like), resins having a carbamoyl group (polyacrylamide (PAAM), polyvinyl pyrrolidone (PVP), polyacrylic acid hydrazide, and the like), and the like. There may also be mentioned polyacrylic acid salts, maleic acid resins, alginates, gelatins and the like, each of which has a carboxyl group as a dissociative group.

Among these, polyvinyl alcohol-based resins are preferable, and in particular, polyvinyl alcohol is preferred.

The content of the water-soluble resin is preferably 9% by weight to 40% by weight, and more preferably 12% by weight to 33% by weight, based on the total solids weight of the ink receiving layer, from the viewpoints of preventing a decrease in the film strength or cracking upon drying due to the content being too small, and preventing a decrease in ink absorbability, which occurs when voids become easily clogged up by the resin due to the content being too large, and thereby the porosity is decreased.

The aforementioned water-soluble resin and the inorganic microparticles that will be described later, which mainly constitute the ink receiving layer, may be respectively formed of a single material, or may be a mixture of plural materials.

The number average degree of polymerization of the polyvinyl alcohol-based resin is preferably 1800 or more, and more preferably 2000 or more, from the viewpoint of preventing cracking. In the case of using the resin with silica microparticles, the type of the water-soluble resin becomes important from the viewpoint of transparency. Particularly, in the case of using anhydrous silica, it is preferable to use a polyvinyl alcohol-based resin as the water-soluble resin, and a polyvinyl alcohol-based resin having a saponification degree of 70% to 99% is more preferred.

The polyvinyl alcohol-based resins include derivatives of the above-mentioned specific examples as well, and the polyvinyl alcohol-based resins may be used alone, or in a combination of two or more species.

The polyvinyl alcohol-based resin has a hydroxyl group in its structural unit, and this hydroxyl group and the silanol group at the surface of silica microparticles form a hydrogen bonding, which facilitates the formation of a three-dimensional network structure having secondary particles of the silica microparticles as chain units. It is believed that as a result of the formation of a three-dimensional network structure as such, an ink receiving layer having a porous structure with high porosity may be formed.

In the inkjet recording medium, the porous ink receiving layer obtained as described above, rapidly absorbs ink on account of the capillary phenomenon, and dots having satisfactory circularity without ink blur may be formed.

(Inorganic Microparticles)

The ink receiving layer in the invention contains inorganic microparticles.

Examples of the inorganic microparticles include silica microparticles, colloidal silica, titanium dioxide, barium sulfate, calcium silicate, zeolites, kaolinite, halloysite, mica, talc, calcium carbonate, magnesium carbonate, calcium sulfate, alumina microparticles, boehmite, pseudoboehmite, and the like. Among them, silica microparticles, colloidal silica, alumina microparticles, and pseudoboehmite are preferable, and in particular, gas-phase process silica microparticles are preferred.

Since the silica microparticles have a particularly large specific surface area, the microparticles have high ink absorbability and efficiency of ink retention. Furthermore, since the silica microparticles have a low refractive index, when dispersion carried out to an appropriate micro-scale particle size, the ink receiving layer may be made transparent, and there is an advantage that high color densities and satisfactory coloring properties may be obtained. As such, the fact that the ink receiving layer is transparent, is important not only for the applications wherein transparency is required, such as OHP sheets, but also in the case of applying the ink receiving layer to recording media such as photographic gloss paper, from the viewpoint of obtaining high color densities, satisfactory coloring properties and high glossiness.

An average primary particle size of the inorganic microparticles is preferably 20 nm or less, more preferably 15 nm or less, and particularly preferably 10 nm or less. When the average primary particle size is 20 nm or less, the ink absorbing characteristics may be effectively enhanced, and at the same time, glossiness at the surface of the ink receiving layer may also be increased.

In particular, since silica microparticles have a silanol group at the surface, and the hydrogen bonding between the silanol groups causes the particles to easily adhere to each other, and also owing to the effect of adherence between the particles via the silanol group and the water-soluble resin, when the average primary particle size is 20 nm or less as described above, the ink receiving layer acquires high porosity, and a highly transparent structure may be formed. Thus, ink absorbing characteristics may be effectively enhanced.

In general, silica microparticles are usually roughly classified into wet process particles and dry process (gas-phase process) particles, on the basis of the production method. In the wet process, methods of obtaining hydrated silica by producing activated silica through acid decomposition of silicates, appropriately polymerizing the activated silica, and then subjecting the resultant to aggregation and sedimentation, are mainly conducted. On the other hand, in the gas phase process, methods of obtaining anhydrous silica according to a process based on high temperature gas phase hydrolysis of silicon halide (flame hydrolysis method), or a process of heating, reducing and gasifying silica sand and cokes using an arc in an electric furnace, and oxidizing the resultant with air (arc method), are mainly conducted.

The gas-phase process silica (anhydrous silica microparticles obtained according to a gas phase process) have differences in the density of silanol group, the presence or absence of pores, and the like, as compared with the hydrated silica, and thus exhibit different properties. However, the gas-phase process silica is suitable for forming a three-dimensional structure having high porosity. The reason for this phenomenon is not known; however, it is speculated that in the case of hydrated silica, the density of silanol group at the microparticle surface is as high as 5 to 8 groups/nm², and the silica microparticles are likely to form compact aggregates (aggregates), whereas in the case of the gas-phase process silica, the density of silanol group at the microparticle surface is as low as 2 to 3 groups/nm², and therefore, the silica microparticles form sparse, soft aggregates (flocculates), consequently forming a structure with high porosity.

According to the invention, the gas-phase process silica microparticles (anhydrous silica) obtainable by the dry process are preferable, and silica microparticles having a density of silanol group at the microparticle surface of 2 to 3 groups/nm² are more preferable.

<Content Ratio of Inorganic Microparticles to Water-Soluble Resin (PB Ratio)>

The content ratio of the inorganic microparticles (preferably, silica microparticles; x) to the water-soluble resin (y) [PB ratio (x/y), amount by weight of the inorganic microparticles relative to 1 part by weight of the water-soluble resin] exerts large influence on the film structure of the ink receiving layer. That is, when the PB ratio is increased, the porosity, pore volume or the surface area (per unit weight) is increased.

Specifically, since an inkjet recording medium may be subjected to receiving stress upon passing through the conveyance system of an inkjet printer, the ink receiving layer needs to have sufficient film strength. Furthermore, in the case of cutting processing the inkjet recording medium into sheets, the ink receiving layer also needs to have sufficient film strength so as to prevent splitting, peeling and the like of the ink receiving layer. Therefore, the PB ratio (x/y) is preferably 4.5 or smaller, from the viewpoint of enhancing the hardness of the ink receiving layer. The PB ratio is more preferably 4.3 or smaller, and particularly preferably 4.15 or smaller.

Although not particularly limited, from the viewpoint of preventing a decrease in the ink absorbability, which occurs when voids are easily clogged up by the resin and thereby the porosity is decreased, the PB ratio is preferably 1.5 or greater, and from the viewpoint of securing high speed ink absorbability in inkjet printers, the PB ratio is more preferably 2 or greater.

For example, when a coating liquid prepared by completely dispersing anhydrous silica microparticles having an average primary particle size of 20 nm or less and a water-soluble resin at a PB ratio (x/y) of 2 to 4.5 in an aqueous solution, is applied on a support, and the coated layer is dried, a three-dimensional network structure having secondary particles of the silica microparticles as chain units is formed, and a transparent porous film having an average pore size of 30 nm or less, a porosity of 50% to 80%, a specific pore volume of 0.5 mL/g or more, and a specific surface area of 100 m²/g or more, may be easily formed.

(Crosslinking Agent)

The ink receiving layer in the invention contains a crosslinking agent.

A preferred embodiment of the ink receiving layer in the invention is such that the layer containing the water-soluble resin further contains a crosslinking agent that is capable of crosslinking the water-soluble resin, and forms a porous layer hardened by a crosslinking reaction between the water-soluble resin and the crosslinking agent. The addition of the crosslinking agent leads to the crosslinking of the water-soluble resin, and thus an ink receiving layer having high hardness may be obtained.

As for the crosslinking agent, it will be favorable to appropriately select a substance that is adequate in the relationship with the water-soluble resin contained in the ink receiving layer. Among them, boron compounds are preferable since the crosslinking reaction occurs rapidly. For example, borax, boric acid, borates (for example, orthoborates, InBO₃, ScBO₃, YBO₃, LaBO₃, Mg₃(BO₃)₂, and CO₃(BO₃)₂), diborates (for example, Mg₂B₂O₅ and CO₂B₂O₅), metaborates (for example, LiBO₂, Ca(BO₂)₂, NaBO₂, KBO₂), tetraborates (for example, Na₂B₄O₇.10H₂O), pentaborates (for example, KB₅O₈.4H₂O, CsB₅O₅), hexaborates (for example, Ca₂B₆O₁₁.7H₂O), and the like may be mentioned. Among them, borax, boric acid and borates are preferable from the viewpoint that they can rapidly bring about the crosslinking reaction, and particularly, boric acid is preferred. It is most preferable to use boric acid in combination with polyvinyl alcohol as the water-soluble resin.

As for the crosslinking agent for polyvinyl alcohol, the compounds shown below may also be mentioned as suitable agents, in addition to the boron compounds.

For example, the compounds are aldehyde-based compounds such as formaldehyde, glyoxal, glutaraldehyde and the like; ketone-based compounds such as diacetyl, cyclopentadione and the like; active halogen compounds such as bis(2-chloroethylurea), 2-hydroxy-4,6-dichloro-1,3,5-triazine, 2,4-dichloro-6-s-triazine sodium salt and the like; active vinyl compounds such as divinylsulfonic acid, 1,3-bis(vinylsulfonyl)-2-propanol, N,N′-ethylenebis(vinylsulfonylacetamide), 1,3,5-triacryloyl-hexahydro-s-triazine and the like; N-methylol compounds such as dimethylolurea, methyloldimethylhydantoin and the like; melamine resins (for example, methylolmelamine and alkylated methylolmelamine); epoxy resins;

isocyanate-based compounds such as 1,6-hexamethylene diisocyanate and the like; aziridine compounds described in U.S. Pat. Nos. 3,017,280 and 2,983,611; carboxyimide-based compounds described in U.S. Pat. No. 3,100,704; epoxy-based compounds such as glycerol triglycidyl ether; ethyleneimino-based compounds such as 1,6-hexamethylene-N,N′-bisethyleneurea and the like; halogenated carboxyaldehyde-based compounds such as mucochloric acid, mucophenoxychloric acid and the like; dioxane-based compounds such as 2,3-dihydroxydioxane and the like; metal-containing compounds such as titanium lactate, aluminum sulfate, chrome alum, potassium alum, zirconyl acetate, chromium acetate and the like; polyamine compounds such as tetraethylenepentamine and the like; hydrazide compounds such as adipic acid dihydrazide and the like; low molecular weight compounds or polymers containing two or more oxazoline groups; and the like.

Furthermore, as the crosslinking agent for the water-soluble resin according to the invention, those polyvalent metal compounds listed below are also preferable. A polyvalent metal compound is capable of not only working as a crosslinking agent, but also further enhancing ozone resistance, image blurring and glossiness.

The polyvalent metal compound is preferably a water-soluble compound, and examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, ammonium copper (II) chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminum sulfate, aluminum alum, aluminum sulfite, aluminum thiosulfate, polyaluminum chloride, aluminum nitrate nonahydrate, aluminum chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, zirconyl acetylacetonate, zirconyl acetate, zirconyl sulfate, zirconyl ammonium carbonate, zirconyl stearate, zirconyl octylate, zirconyl nitrate, zirconyl oxychloride, zirconyl hydroxychloride, chromium acetate, chromium sulfate, magnesium sulfate, magnesium chloride hexahydrate, magnesium citrate nonahydrate, sodium phosphotungstate, sodium tungsten citrate, dodecatungstophosphoric acid n-hydrate, dodecatungstosilicic acid 26-hydrate, molybdenum chloride, dodecamolybdophosphoric acid n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride, bismuth nitrate, and the like.

Among them, aluminum-containing compounds (water-soluble aluminum compounds) such as aluminum sulfate, aluminum alum, aluminum sulfite, aluminum thiosulfate, polyaluminum chloride, aluminum nitrate nonahydrate, and aluminum chloride hexahydrate; zirconyl-containing compounds (water-soluble zirconyl compounds) such as zirconyl acetylacetonate, zirconyl acetate, zirconyl sulfate, zirconyl ammonium carbonate, zirconyl stearate, zirconyl octylate, zirconyl nitrate, zirconyl oxychloride, and zirconyl hydroxychloride; and titanium-containing compounds such as titanium tetrachloride, tetraisopropyl titanate, titanium acetylacetonate, and titanium lactate are preferable, and in particular, polyaluminum chloride, zirconyl acetate, zirconyl ammonium carbonate and zirconyl oxychloride are preferred.

Among them, the crosslinking agent according to the invention is particularly preferably boron compounds and zirconyl compounds.

According to the invention, for example, in the case of using polyvinyl alcohol as the water-soluble resin and boric acid as the crosslinking agent, the crosslinking agent is preferably contained in an amount of 5% by weight to 50% by weight, and more preferably 8% by weight to 30% by weight, based on the water-soluble resin, in order to sufficiently obtain the effects of the invention by suppressing swelling of polyvinyl alcohol, without causing problems such as cracking in the ink receiving layer or scratch resistance.

The crosslinking agents described above may be used alone, or in a combination of two or more species. From the viewpoint of working as a suitable crosslinking agent and at the same time, further enhancing ozone resistance, image blurring and glossiness, the polyvalent metal compound (particularly preferably, a zirconyl compound) is incorporated at least in an amount of preferably 0.1% by weight or more, more preferably 0.5% by weight or more, and particularly preferably 1.0% by weight or more, based on the water-soluble resin. Although not particularly limited, the upper limit of the content of the polyvalent metal compound is preferably 50% by weight, from the viewpoints of image density, ink absorbability, suppression of curling of the recording medium, and the like.

(Ammonium Carbonate)

The ink receiving layer in the invention preferably further contains ammonium carbonate. When ammonium carbonate is incorporated into the ink receiving layer, an ink receiving layer having high hardness may be obtained.

The content of ammonium carbonate is preferably 8% by weight or more, more preferably 9% by weight or more, and particularly preferably 11% by weight or more, based on the water-soluble resin. The upper limit is not particularly limited, but from the viewpoints of image density, ink absorbability, suppression of curling of the recording medium and the like, the upper limit is preferably 20% by weight.

(Water-Dispersible Cationic Resin)

As a component of the ink receiving layer in the invention, a water-dispersible cationic resin may be incorporated. The water-dispersible cationic resin is preferably a urethane resin which is a cation-modified self-emulsifying polymer, and preferably has a glass transition temperature of lower than 50° C.

This “cation-modified self-emulsifying polymer” means a polymer compound which is capable of spontaneously forming a stable emulsified dispersion in a water-based dispersion medium, without using any emulsifier or surfactant, or with the addition of a very small amount of emulsifier or surfactant if ever used. From a quantitative aspect, the “cation-modified self-emulsifying polymer” means a polymer having stable emulsion dispersibility at room temperature of 25° C. at a concentration of 0.5% by weight or more, preferably 1% by weight or more, and particularly preferably 3% by weight or more with respect to the water-based dispersion medium.

The “cation-modified self-emulsifying polymer” in the invention may be more specifically, for example, a polymer having a cationic group such as a primary, secondary or tertiary amino group, or a quaternary ammonium group being obtained by an addition polymerization or a condensation polymerization.

Vinyl-polymerized polymers which are effective as the aforementioned polymer, may be, for example, polymers that are obtainable by polymerizing the following vinyl monomers. That is, there may be mentioned acrylic acid esters or methacrylic acid esters (in which the ester group is an alkyl group or an aryl group, all of which may be substituted; for example, a methyl group, an ethyl group, an n-propyl group, an isopropyl group, an n-butyl group, a sec-butyl group, a tert-butyl group, a hexyl group, a 2-ethylhexyl group, a tert-octyl group, a 2-chloroethyl group, a cyanoethyl group, a 2-acetoxyethyl group, a tetrahydrofurfuryl group, a 5-hydroxypentyl group, a cyclohexyl group, a benzyl group, a hydroxyethyl group, a 3-methoxybutyl group, a 2-(2-methoxyethoxy)ethyl group, a 2,2,2-trifluoroethyl group, a 1H,1H,2H,2H-perfluorodecyl group, a phenyl group, a 2,4,5-trimethylphenyl group, a 4-chlorophenyl group, and the like);

vinyl esters, specifically, aliphatic carboxylic acid vinyl esters which may be substituted (for example, vinyl acetate, vinyl propionate, vinyl butylate, vinyl isobutylate, vinyl caproate, vinyl chloroacetate, and the like), aromatic carboxylic acid vinyl esters which may be substituted (for example, vinyl benzoate, vinyl 4-methylbenzoate, vinyl salicylate, and the like);

acrylamides, specifically, acrylamide, N-monosubstituted acrylamide, N-disubstituted acrylamide (the substituent may be an alkyl group, an aryl group or a silyl group, all of which may be substituted; for example, a methyl group, an n-propyl group, an isopropyl group, an n-butyl group, a tert-butyl group, a tert-octyl group, a cyclohexyl group, a benzyl group, a hydroxymethyl group, an alkoxymethyl group, a phenyl group, a 2,4,5-trimethylphenyl group, a 4-chlorophenyl group, a trimethylsilyl group, and the like);

methacrylamides, specifically, methacrylamide, N-monosubstituted methacrylamide, N-disubstituted methacrylamide (the substituent may be an alkyl group, an aryl group or a silyl group, all of which may be substituted; for example, a methyl group, an n-propyl group, an isopropyl group, an n-butyl group, a tert-butyl group, a tert-octyl group, a cyclohexyl group, a benzyl group, a hydroxymethyl group, an alkoxymethyl group, a phenyl group, a 2,4,5-trimethylphenyl group, a 4-chlorophenyl group, a trimethylsilyl group, and the like);

olefins (for example, ethylene, propylene, 1-pentene, vinyl chloride, vinylidene chloride, isoprene, chloroprene, butadiene, and the like), styrenes (for example, styrene, methylstyrene, isopropylstyrene, methoxystyrene, acetoxystyrene, chlorostyrene, and the like), vinyl ethers (for example, methyl vinyl ether, butyl vinyl ether, hexyl vinyl ether, methoxyethyl vinyl ether, and the like); and the like.

Other examples of the vinyl monomer include crotonic acid esters, itaconic acid esters, maleic acid diesters, fumaric acid diesters, methyl vinyl ketone, phenyl vinyl ketone, methoxyethyl vinyl ketone, N-vinyl oxazolidone, N-vinyl pyrrolidone, methylenemalononitrile, diphenyl-2-acryloyloxyethyl phosphate, diphenyl-2-methacryloyloxyethyl phosphate, dibutyl-2-acryloyloxyethyl phosphate, dioctyl-2-methacryloyloxyethyl phosphate, and the like.

As for the monomer having a cationic group, there may be mentioned, for example, a monomer having a tertiary amino group, such as dialkylaminoethyl methacrylate or dialkylaminoethyl acrylate, and the like.

As the polyurethane that may be applied to the cationic group-containing polymer, there may be mentioned, for example, polyurethanes synthesized by an addition polymerization of a variety of combinations of diol compounds and diisocyanate compounds listed below.

Specific examples of the diol compounds include ethylene glycol, 1,2-propanediol, 1,3-propanediol, 1,2-butanediol, 1,3-butanediol, 2,3-butanediol, 2,2-dimethyl-1,3-propanediol, 1,2-pentanediol, 1,4-pentanediol, 1,5-pentanediol, 2,4-pentanediol, 3,3-dimethyl-1,2-butanediol, 2-ethyl-2-methyl-1,3-propanediol, 1,2-hexanediol, 1,5-hexanediol, 1,6-hexanediol, 2,5-hexanediol, 2-methyl-2,4-pentanediol, 2,2-diethyl-1,3-propanediol, 2,4-dimethyl-2,4-pentanediol, 1,7-heptanediol, 2-methyl-2-propyl-1,3-propanediol, 2,5-dimethyl-2,5-hexanediol, 2-ethyl-1,3-hexanediol, 1,2-octanediol, 1,8-octanediol, 2,2,4-trimethyl-1,3-pentanediol, 1,4-cyclohexanedimethanol, hydroquinone, diethylene glycol, triethylene glycol, dipropylene glycol, tripropylene glycol, polyethylene glycol (average molecular weight=200, 300, 400, 600, 1000, 1500, 4000), polypropylene glycol (average molecular weight=200, 400, 1000), polyester polyol, 4,4′-dihydroxy-diphenyl-2,2-propane, 4,4′-dihydroxyphenylsulfone, and the like.

Specific examples of the diisocyanate compounds include methylene diisocyanate, ethylene diisocyanate, isophoron diisocyanate, hexamethylene diisocyanate, 1,4-cyclohexane diisocyanate, 2,4-toluene diisocyanate, 2,6-toluene diisocyanate, 1,3-xylene diisocyanate, 1,5-naphthalene diisocyanate, m-phenylene diisocyanate, p-phenylene diisocyanate, 3,3′-dimethyl-4,4′-diphenylmethane diisocyanate, 3,3′-dimethylbiphenylene diisocyanate, 4,4′-biphenylene diisocyanate, dicyclohexylmethane diisocyanate, methylenebis(4-cyclohexyl isocyanate), and the like.

The cationic group contained in the cationic group-containing polyurethane includes cationic groups such as primary, secondary and tertiary amines and quaternary ammonium salts. The self-emulsifying polymer used in the aqueous dispersion according to the invention is preferably a urethane resin having a cationic group such as a tertiary amine or a quaternary ammonium salt.

The polyurethane having a cationic group may be obtained by, for example, using a diol such as mentioned above, to which a cationic group has been introduced, in the synthesis of polyurethane. In the case of a quaternary ammonium salt, a polyurethane containing a tertiary amino group may be quaternized with a quaternizing agent.

The diol compounds and diisocyanate compounds that may be used in the synthesis of polyurethane may be used singly, or two or more species, each respectively. The diol compounds and diisocyanate compounds may also be used singly, or two or more species at any proportion, each respectively, in accordance with various purposes (for example, adjustment of the glass transition temperature (Tg) of the polymer, enhancement of solubility, impartation of compatibility with the binder, improvement in stability of the dispersion, and the like).

(Mordant)

The ink receiving layer in the invention preferably contains a mordant such as shown below, for the purpose of further improving the image blur resistance over time, and water resistance. The mordant preferably includes an organic mordant such as a cationic polymer (cationic mordant), and an inorganic mordant such as a water-soluble metal compound. The cationic mordant which is suitably used is a polymer mordant having a primary, secondary or tertiary amino group or a quaternary ammonium group as a cationic functional group. A cationic non-polymer mordant may also be used.

The polymer mordant is preferably a product obtainable as a homopolymer of a monomer having a primary, secondary or tertiary amino group or a salt thereof, or a quaternary ammonium salt group (mordant monomer), or a copolymer or condensation polymer of the mordant monomer with another monomer (non-mordant monomer). Furthermore, these polymer mordants may be used in the form of a water-soluble polymer or water-dispersible latex particles.

Specific examples of the mordant monomer include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride;

trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, N,N-diethyl-N-methyl-N-2-(4-vinylphenyl)ethylammonium acetate;

a quaternization product of N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminoethyl (meth)acrylamide, N,N-diethylaminoethyl (meth)acrylamide, N,N-dimethylaminopropyl (meth)acrylamide, or N,N-diethylaminopropyl (meth)acrylamide with methyl chloride, ethyl chloride, methyl bromide, ethyl bromide, methyl iodide or ethyl iodide; or a sulfonate, alkylsulfonate, acetate, alkylcarboxylate or the like obtained by an anion exchange thereof.

Specific examples of the compound include monomethyldiallylammonium chloride, trimethyl-2-(methacryloyloxy)ethylammonium chloride, triethyl-2-(methacryloyloxy)ethylammonium chloride, trimethyl-2-(acryloyloxy)ethylammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylammonium chloride, trimethyl-2-(acryloylamino)ethylammonium chloride, triethyl-2-(acryloylamino)ethylammonium chloride, trimethyl-3-(methacryloylamino)propylammonium chloride, triethyl-3-(methacryloylamino)propylammonium chloride, trimethyl-3-(acryloylamino)propylammonium chloride, triethyl-3-(acryloylamino)propylammonium chloride;

N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy)ethylammonium bromide, trimethyl-3-(acryloylamino)propylammonium bromide, trimethyl-2-(methacryloyloxy)ethylammonium sulfonate, trimethyl-3-(acryloylamino)propylammonium acetate, and the like. In addition to these, N-vinylimidazole, N-vinyl-2-methylimidazole and the like may also be mentioned as copolymerizable monomers. Furthermore, a product obtained using a polymerization unit such as N-vinylacetamide or N-vinylformamide, by converting the unit into a vinylamine unit by hydrolysis after polymerization, and a salt formed from this product, may also be used.

The non-mordant monomer refers to a monomer which does not contain a basic or cationic moiety such as a primary, secondary or tertiary amino group or a salt thereof, or a quaternary ammonium salt group, and does not exhibit interaction, or exhibits substantially small interaction, with a dye in the inkjet ink. For example, a (meth)acrylic acid alkyl ester; a (meth)acrylic acid cycloalkyl ester such as cyclohexyl (meth)acrylate or the like; a (meth)acrylic acid aryl ester such as phenyl (meth)acrylate or the like; a (meth)acrylic acid aralkyl ester such as benzyl (meth)acrylate or the like; aromatic vinyls such as styrene, vinyltoluene, α-methylstyrene or the like; vinyl esters such as vinyl acetate, vinyl propionate, vinyl versatate or the like; allyl esters such as allyl acetate or the like; halogen-containing monomers such as vinylidene chloride, vinyl chloride or the like; vinyl cyanides such as (meth)acrylonitrile or the like; olefins such as ethylene, propylene or the like; and the like may be mentioned.

The (meth)acrylic acid alkyl ester is preferably a (meth)acrylic acid alkyl ester having an alkyl moiety having 1 to 18 carbon atoms. Specific examples include methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, lauryl (meth)acrylate, stearyl (meth)acrylate, and the like. Among these, methyl acrylate, ethyl acrylate, methyl methacrylate, ethyl methacrylate, and hydroxyethyl methacrylate are preferred. These non-mordant monomers may also be used alone, or in a combination of two or more species.

Furthermore, the polymer mordant preferably includes polydiallyldimethylammonium chloride, polymethacryloyloxyethyl-β-hydroxyethyldimethylammonium chloride, polyethyleneimine, a polyamide-polyamine resin, cationized starch, a dicyandiamide-formalin condensate, dimethyl-2-hydroxypropylammonium salt polymerization product, polyamidine, polyvinylamine, a dicyan-based cation resin represented by a dicyandiamide-formalin condensation polymer, a polyamine-based cationic resin represented by a dicyanamide-diethylenetriamine condensation polymer, epichlorohydrin-dimethylamine addition polymerization product, a dimethyldiallylammonium chloride-SO₂ copolymer, a diallylamine salt-SO₂ copolymer, and the like.

Specific examples of the polymer mordant also include the compounds described in JP-A Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134 and 1-161236; U.S. Pat. Nos. 2,484,430, 2,548,564, 3,148,061, 3,309,690, 4,115,124, 4,124,386, 4,193,800, 4,273,853, 4,282,305 and 4,450,224; JP-A Nos. 1-161236, 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, and 2001-301314; and the like.

The inorganic mordant may be a polyvalent water-soluble metal salt or a hydrophobic metal salt compound other than those mentioned above. For example, a salt or a complex of a metal selected from magnesium, aluminum, calcium, scandium, titanium, vanadium, manganese, iron, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten and bismuth, may be mentioned.

Specific examples include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, ammonium cupric chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminum sulfate, aluminum alum, basic polyaluminum hydroxide, aluminum sulfite, aluminum thiosulfate, polyaluminum chloride, aluminum nitrate nonahydrate, aluminum chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, zirconium acetylacetonate, zirconyl acetate, zirconyl sulfate, zirconyl ammonium carbonate, zirconyl stearate, zirconyl octylate, zirconyl nitrate, zirconium oxychloride, zirconium hydroxychloride, chromium acetate, chromium sulfate, magnesium sulfate, magnesium chloride hexahydrate, magnesium citrate nonahydrate, sodium phosphotungstate, sodium tungsten citrate, dodecatungstophosphoric acid n-hydrate, dodecatungstosilicic acid 26-hydrate, molybdenum chloride, dodecamolybdophosphoric acid n-hydrate, potassium nitrate, manganese nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride, bismuth nitrate, and the like. Among them, aluminum-containing compounds, titanium-containing compounds, zirconium-containing compounds, and compounds (salts or complexes) of the metals belonging to Group IIIB of the Periodic Table are preferable.

The “polyvalent metal compounds” listed in the section of (Crosslinking agent) may also be suitably used as mordants.

When the mordant is added to the ink receiving layer, an addition amount of the mordant is preferably from 0.01 g/m² to 5 g/m².

(Other Components)

The ink receiving layer related to the invention is constituted to contain the following components as necessary.

That is, for the purpose of suppressing deterioration of color materials of the ink, the ink receiving layer may contain various color fading preventing agents such as ultraviolet absorbents, antioxidants, singlet oxygen quenchers or the like.

The ultraviolet absorbents may include cinnamic acid derivatives, benzophenone derivatives, benzotriazolylphenol derivatives, and the like. For example, butyl α-cyanophenylcinnamate, o-benzotriazolephenol, o-benzotriazole-p-chlorophenol, o-benzotriazole-2,4-di-t-butylphenol, o-benzotriazole-2,4-di-t-octylphenol, and the like may be mentioned. Hindered phenol compounds may also be used as the ultraviolet absorbent, and specifically, a phenol derivative substituted by one or more branched alkyl groups at least at the 2-position or the 6-position, is preferable.

Benzotriazole-based ultraviolet absorbents, salicylic acid-based ultraviolet absorbents, cyanoacrylate-based ultraviolet absorbents, oxalic acid anilide-based ultraviolet absorbents, and the like may also be used. These ultraviolet absorbents are described in, for example, JP-A Nos. 47-10537, 58-111942, 58-212844, 59-19945, 59-46646, 59-109055 and 63-53544; Japanese Patent Application Publication (JP-B) Nos. 36-10466, 42-26187, 48-30492, 48-31255, 48-41572, 48-54965 and 50-10726; U.S. Pat. Nos. 2,719,086, 3,707,375, 3,754,919 and 4,220,711; and the like.

Fluorescent whitening agents may also be used as ultraviolet absorbents, and for example, coumalin-based fluorescent whitening agents and the like may be mentioned. Specifically, examples are described in JP-B Nos. 45-4699, 54-5324, and the like.

Examples of the antioxidants include those described in EP Nos. 223739, 309401, 309402, 310551, 310552 and 459416; DE Patent No. 3435443; JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381, and 63-113536;

JP-A Nos. 63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437 and 5-170361; JP-B Nos. 48-43295 and 48-33212; U.S. Pat. Nos. 4,814,262 and 4,980,275; and the like.

Specific examples of the antioxidants include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4-tetrahydroquinoline, nickel cyclohexanoate, 2,2-bis(4-hydroxyphenyl)propane, 1,1-bis(4-hydroxyphenyl)-2-ethylhexane, 2-methyl-4-methoxydiphenylamine, 1-methyl-2-phenylindole, and the like.

These color fading preventing agents may be used alone, or in a combination of two or more species. The color fading preventing agent may be dissolved in water, dispersed or emulsified, and may also be included in microcapsules. An addition amount of the color fading preventing agent is preferably from 0.01% by weight to 10% by weight of the coating liquid for ink receiving layer.

In the invention, the ink receiving layer preferably contains a high boiling point organic solvent for preventing curling. The high boiling point organic solvent is preferably water-soluble, and examples of the water-soluble high boiling point organic solvent include alcohols such as ethylene glycol, propylene glycol, diethylene glycol, triethylene glycol, glycerin, diethylene glycol monobutyl ether (DEGmBE), triethylene glycol monobutyl ether, glycerin monomethyl ether, 1,2,3-butanetriol, 1,2,4-butanetriol, 1,2,4-pentanetriol, 1,2,6-hexanetriol, thiodiglycol, triethanolamine, and polyethylene glycol (weight average molecular weight being 400 or less). A preferred example is diethylene glycol monobutyl ether (DEGmBE).

The content of the high boiling point organic solvent in the coating liquid for ink receiving layer is preferably from 0.05% by weight to 1% by weight, and particularly preferably from 0.1% by weight to 0.6% by weight.

The coating liquid for ink receiving layer may also contain various inorganic salts, or an acid or alkali as a pH adjusting agent for the purpose of enhancing the dispersibility of the microparticles.

Moreover, metal oxide microparticles having electronic conductivity may be incorporated for the purpose of suppressing frictional electrification or peeling electrification of the surface, and various matting agents may be incorporated for the purpose of reducing the frictional characteristics of the surface.

(Support)

As for the support to be used in the invention, a transparent support formed from a transparent material such as a plastic, and an opaque support formed from an opaque material such as paper may all be used. It is preferable for the support to have a resin layer including a thermoplastic resin such as polyethylene (hereinafter, sometimes simply referred to as “thermoplastic resin-containing layer”), as the outermost layer on the side where the ink receiving layer is provided. The thermoplastic resin-containing layer may also be provided on both sides of a paper substrate in accordance with the purpose or the like.

Next, the thermoplastic resin will be explained.

The thermoplastic resin is not particularly limited, and may be appropriately selected from microgranulation products or latexes of known thermoplastic resins such as polyolefin resins (for example, homopolymers of α-olefins, such as polyethylene or polypropylene, or mixtures thereof), and used. Among them, a polyolefin resin (particularly, polyethylene resin) is preferable as the thermoplastic resin.

The polyolefin resin is not particularly limited in a molecular weight as long as extrusion coating is possible, and may be appropriately selected according to the purpose. Usually, a polyolefin resin having a molecular weight in a range of 20,000 to 200,000 is used.

The polyethylene resin is not particularly limited, and may be appropriately selected according to the purpose. Examples thereof include high density polyethylene (HDPE), low density polyethylene (LDPE), linear low density polyethylene (L-LDPE), and the like.

It is preferable to incorporate a white pigment, a coloring pigment or fluorescent whitening agent, and stabilizers such as phenol, bisphenol, thiobisphenol, amines, benzophenone, a salicylic acid salt, benzotriazole and an organic metal compound.

Examples of the method for forming the thermoplastic resin-containing layer preferably include melt extrusion, wet lamination, dry lamination and the like. Among them, melt extrusion is most preferable. In order to form a thermoplastic resin-containing layer by melt extrusion, for the purpose of strengthening the adhesion between the thermoplastic resin-containing layer and its underlying layer (hereinafter, may be referred to as “coating layer”), it is preferable to provide a preliminary treatment at the surface of the coating layer.

The preliminary treatment may be an acid etching treatment using a sulfuric acid-chromic acid mixed liquid, a flame treatment using a gas flame, an ultraviolet irradiation treatment, a corona discharge treatment, a glow discharge treatment, an anchor coat treatment using alkyl titanate, or the like. The treatment may be appropriately selected and carried out, but particularly from the viewpoint of convenience, a corona discharge treatment is preferred. In the case of the corona discharge treatment, it is necessary to carry out the treatment so that the contact angle with water becomes 70° or less.

—Paper Substrate—

For the support according to the invention, a paper substrate which is an opaque support may be used.

The paper substrate may be any of a natural pulp paper containing typical natural pulp as a main component, a mixed paper formed from natural pulp and synthetic fiber, a synthetic fiber paper containing synthetic fiber as a main component, and a so-called synthetic paper produced by making a synthetic resin film of polystyrene, polyethylene terephthalate or polypropylene into pseudo-paper. Among them, a natural pulp paper (hereinafter, simply referred to as “base paper”) is particularly preferable. The base paper may be used with a neutral paper (pH 5 to 9) or an acidic paper, but a neutral paper is more preferable.

The base paper may be made of a product prepared by using natural pulp selected from softwood, hardwood and the like as a main raw material, and adding, according to necessity, a loading material such as clay, talc, calcium carbonate or urea resin microparticles; a sizing agent such as rosin, an alkyl ketene dimer, a higher fatty acid, an epoxidated fatty acid amide, paraffin wax or alkenyl succinic acid; a paper strength augmenting agent such as starch, polyamide-polyamine-epichlorohydrin or polyacrylamide; a fixing agent such as aluminum sulfate or a cationic polymer; or the like. A softening agent such as a surfactant may also be added. Furthermore, a synthetic paper made using synthetic pulp instead of the natural pulp may also be used, and a paper made by mixing natural pulp and synthetic pulp at any ratio may also be used. Among them, it is preferable to use hardwood pulp which is composed of short fibers and increases smoothness. The freeness of the pulp material to be used is preferably in a range of 200 mL to 500 mL (C.S.F.), and more preferably in a range of 300 mL to 400 mL.

The paper substrate may contain other components such as a sizing agent, a softening agent, a paper strengthening agent and a fixing agent. The sizing agent may be rosin, paraffin wax, a higher fatty acid salt, an alkenyl succinic acid salt, a fatty acid anhydride, a styrene-maleic anhydride copolymer, an alkyl ketene dimer, an epoxidated fatty acid amide, or the like. The softening agent may be a reaction product of a maleic anhydride copolymer and a polyalkylene polyamine, a quaternary ammonium salt of a higher fatty acid, or the like. The paper strengthening agent may be polyacrylamide, starch, polyvinyl alcohol, a melamine-formaldehyde condensation product, gelatin or the like. The fixing agent may be aluminum sulfate, polyamide-polyamine-epichlorohydrin, or the like. In addition to these, a dye, a fluorescent dye, an antistatic agent and the like may be added according to necessity.

The paper substrate is preferably subjected to an activation treatment such as a corona discharge treatment, a flame treatment, a glow discharge treatment or a plasma treatment, in advance before the formation of the previously mentioned thermoplastic resin-containing layer.

—Calendering Treatment—

The support according to the invention may be subjected to a calendering treatment.

After providing a thermoplastic resin-containing layer on a paper substrate, a calendering treatment is applied under specific conditions. Thereby, planarity of the thermoplastic resin-containing layer may be obtained, and also, high glossiness and high planarity of the surface of the ink receiving layer formed with the thermoplastic resin-containing layer lying underneath, and high quality image formability may be secured.

The calendering treatment is preferably performed using a soft calender having at least one of a roll pair constituted of a metal roll (preferably constituted of a metal roll and a resin roll), or a supercalender, or using both, raising the surface temperature of the metal roll to a temperature at or above the glass transition temperature of the thermoplastic resin, and at the same time, setting the nip pressure between the roll nips in the roll pair at 50 kg/cm to 400 kg/cm.

Hereinafter, the soft calender having a metal roll and a resin roll, and the supercalender will be described in detail. The metal roll is a cylindrical or columnar roll having a flat surface, and may be appropriately selected from known metal rolls and used, without being limited on the material or the like, as long as the roll has a heating unit in the inside. Since the metal roll is contacted with the surface of the support on the recording surface side, that is, on the side where the ink receiving layer is formed, of the surfaces on the two sides of the support during the calendering treatment, the surface roughness is such that it is more preferable as the surface is smoother. Specifically, the surface roughness is preferably 0.3 s or less, and more suitably 0.2 s or less, in terms of the surface roughness defined by JIS B0601.

The surface temperature of the metal roll during the treatment is preferably 70° C. to 250° C., generally when a paper substrate is subjected to the treatment. In this regard, when a paper substrate provided with the previously mentioned thermoplastic resin-containing layer, is subjected to the treatment, the surface temperature is preferably a temperature at or above the glass transition temperature, Tg, of the thermoplastic resin contained in the thermoplastic resin-containing layer, and is more preferably the Tg or higher but Tg+40° C. or lower.

The resin roll may be appropriately selected from synthetic resin rolls formed from a polyurethane resin, a polyamide resin and the like, and a roll having a Shore D hardness of 60 to 90 is suitable.

The nip pressure of the roll pair having the metal roll is suitably 50 kg/cm to 400 kg/cm, and preferably 100 kg/cm to 300 kg/cm. In the case of performing the treatment using a soft calender arranged to have a single roll pair which is constituted as described above, and/or a supercalender, it is preferable to perform the treatment substantially once or twice.

The support that is used in the inkjet recording medium is not particularly limited, and a transparent support formed from a transparent material such as a plastic may also be used. As the material which may be used for the transparent support, a transparent material having a property to endure the radiation heat generated when used in an OHP or a backlight display is preferable. Examples of such a material include polyesters such as polyethylene terephthalate (PET); polysulfone, polyphenylene oxide, polyimide, polycarbonate, polyamide, and the like. Among them, polyesters are preferable, and in particular, polyethylene terephthalate is preferred.

Furthermore, an optical disk exclusive for read-only memory, such as CD-ROM or DVD-ROM, a writable type optical disk such as CD-R or DVD-R, or a rewritable optical disk may be used as a support, and an ink receiving layer and a glossiness imparting layer may be provided on the labeled surface side.

The constituent layers (for example, ink receiving layer) of the inkjet recording medium of the invention may be incorporated with a polymer microparticle dispersion. The polymer microparticle dispersion is used for the purpose of improving film physical properties, such as dimensional stability, curl preventing, adhesion preventing, and cracking preventing of the film. Descriptions on the polymer microparticle dispersion may be found in JP-A Nos. 62-245258, 62-1316648 and 62-110066. In addition, when a polymer microparticle dispersion having a low glass transition temperature (40° C. or lower) is added to the ink receiving layer, cracking in the layer or curling may be prevented. Also, when a polymer microparticle dispersion having high glass transition temperature is added to a back layer, curling may be prevented.

In inkjet recording, since the ink receiving layer needs to have an absorption capacity sufficient to absorb all of liquid droplets, the layer thickness of the ink receiving layer of the invention is to be determined in accordance with the porosity of the layer. For example, when the amount of ink is 8 nL/mm², and the porosity is 60%, a film having a thickness of about 15 μm or more is needed. When this point is taken into consideration, in the case of inkjet recording, the thickness of the ink receiving layer is preferably from 10 μm to 50 μm.

A pore size of the ink receiving layer is preferably 0.005 μm to 0.030 μm, and more preferably 0.01 μm to 0.025 μm, as a median size. The porosity and the pore median size may be measured using a mercury porosimeter (trade name: PORESIZER-9320-PC2, manufactured by Shimadzu Corp.).

It is preferable that the ink receiving layer has excellent transparency. As the reference, the haze value obtainable when the ink receiving layer is formed on a transparent film support, is preferably 30% or less, and more preferably 20% or less. The haze value may be measured using a haze meter (trade name: HGM-2DP, manufactured by Suga Test Instruments Co., Ltd.).

—Inkjet Recording System—

In the inkjet recording method of the invention, the inkjet recording system is not particularly limited, and any known systems, for example, a charge control system of ejecting ink using electrostatic attractive force; a drop-on-demand system (pressure pulse system) of using the oscillating pressure of a piezoelectric element; an acoustic inkjet system of converting electric signals to an acoustic beam, propagating the acoustic beam to the ink, and ejecting the ink using the radiation pressure; a thermal inkjet system of forming air bubbles by heating the ink, and using the pressure generated therefrom; and the like are used. The inkjet recording system includes a system of injecting a large number of small volume droplets of a low-concentration ink called photo ink, a system of improving the image quality using plural inks having substantially the same color but different concentrations, or a system of using a colorless and transparent ink.

(Drying Process)

In the inkjet recording method of the invention, drying may be carried out after printing images (preferably, within 10 minutes after printing). The inkjet recording apparatus is equipped with a drying apparatus in an in-line or off-line manner.

As for the drying method, a drying method by heating is preferable, and the heating method is carried out by a conventional method such as heating with warm air or hot air using a hot air blowing dryer, infrared drying using an infrared lamp, heating using a heated roll, or dielectric heating. In order to obtain recorded images which are excellent in the density and suppressing the color change from immediately after printing, without causing a problem of, for example, so-called curling due to excessive heating, it is preferable to perform a drying treatment within 2 minutes, and more preferably within 1 minute, from immediately after printing. It is preferable to perform drying at 50° C. to 200° C. for one second to 5 minutes, and more preferably at 50° C. to 150° C. for one second to 5 minutes.

All publications, patent applications, and technical standards mentioned in this specification are herein incorporated by reference to the same extent as if each individual publication, patent application, or technical standard was specifically and individually indicated to be incorporated by reference.

### EXAMPLES

Hereinafter, the present invention will be more specifically described by way of Examples. The scope of the invention is not intended to be limited to the specific examples shown below. In particular, unless stated otherwise, the terms “part” and “%” are based on weight.

### Example 1

### Preparation of Support

50 parts of LBKP obtained from acacia and 50 parts of LBKP obtained from aspen were respectively processed by beating using a disc refiner to obtain a Canadian freeness of 300 mL, and thus a pulp slurry was prepared.

Subsequently, to the pulp slurry obtained as described above were added 1.3% of cation-modified starch (trade name: CAT 0304L, manufactured by Nippon NSC, Ltd.), 0.15% of anionic polyacrylamide (trade name: DA4104, manufactured by Seiko PMC Corp.), 0.29% of an alkyl ketene dimer (trade name: SIZEPINE K, manufactured by Arakawa Chemical Industries, Ltd.), 0.29% of epoxidated behenic acid amide, and 0.32% of polyamide-polyamine-epichlorohydrin (trade name: ARAFIX 100, manufactured by Arakawa Chemical Industries, Ltd.), based on the pulp, and thereafter, 0.12% of an antifoaming agent was added thereto.

The pulp slurry prepared as described above was made into paper using a Fourdrinier paper machine. In a process of drying the paper by pressing the felt surface of the web in a drum dryer cylinder, with a dryer canvas interposed between the felt surface and the dryer cylinder, drying was performed with the tensile strength of the dryer canvas set at 1.6 kg/cm, and then polyvinyl alcohol (trade name: KL-118, manufactured by Kuraray Co., Ltd.) was coated by size pressing in an amount of 1 g/m² on both sides of a base paper. The coated base paper was dried and was subjected to a calendering treatment. The base paper was made to have a basis weight of 166 g/m², and thus a base paper (substrate paper) having a thickness of 160 μm was obtained.

After performing a corona discharge treatment on the wire surface (back surface) of the obtained substrate paper, high density polyethylene was coated thereon in an amount of 25 g/m² using a melt extruder, and thus a thermoplastic resin layer having a matt surface was formed. The thermoplastic resin layer of this back surface side was further subjected to a corona discharge treatment, and then a dispersion prepared as an antistatic agent by dispersing aluminum oxide (trade name: “ALUMINASIL 100”, manufactured by Nissan Chemical Industries, Ltd.) and silicon dioxide (trade name: “SNOWTEX 0”, manufactured by Nissan Chemical Industries, Ltd.) at a ratio of 1:2 by weight in water, was coated to obtain a dry weight of 0.2 g/m². Subsequently, the surface was treated with corona discharge, and then a polyethylene having a density of 0.93 g/cm³ and containing 10% of titanium oxide was coated on the surface using a melt extruder in an amount of 24 g/m².

(Preparation of Coating Liquid A for Ink Receiving Layer (First Liquid))

(1) Gas-phase process silica microparticles, (2) ion-exchanged water, (3) “SHALLOL DC-902P”, and (4) “ZA-30”, as shown in the following composition, were mixed, and the mixture was dispersed using a bead mill (trade name: KD-P, manufactured by Shinmaru Enterprises Corp.). The dispersion was then heated to 45° C., and was maintained for 20 hours. Subsequently, (5) an aqueous solution of boric acid, (6) a dimethylamine-epichlorohydrin-polyalkylene polyamine condensation product, (7) a polyvinyl alcohol solution, (8) “SUPERFLEX 650-5”, and (9) ethanol water were added as shown below to the dispersion at 30° C., and thus a coating liquid A for ink receiving layer (first liquid) was prepared.

| | |
|---|---|
| (1) Gas-phase process silica microparticles | 100 parts |
| (trade name: AEROSIL 300SF75, manufactured | |
| by Nippon Aerosil Co., Ltd.) | |
| (2) Ion-exchanged water | 555 parts |
| (3) “SHALLOL DC-902P” | 8.7 parts |
| (dispersant, manufactured by Daiichi Kogyo | |
| Seiyaku Co., Ltd., 51.5% aqueous solution) | |
| (4) Zirconyl acetate | 2.7 parts |
| (trade name: “ZA-30”, manufactured | |
| by Daiichi Kigenso Kagaku Kogyo Co., Ltd., | |
| 50% aqueous solution) | |
| (5) Boric acid (crosslinking agent) | 50 parts |
| (7.5% aqueous solution) | |
| (6) Dimethylamine-epichlorohydrin-polyalkylene | 0.77 parts |
| polyamine polycondensate | |
| (trade name: “SC-505”, Hymo Co., Ltd., | |
| 50% aqueous solution) | |
| (7) Polyvinyl alcohol (water-soluble resin) | 290 parts |
| solution having the following composition | |
| (8) “SUPERFLEX 650-5” | 25 parts |
| (cation-modified polyurethane, manufactured by | |
| Daiichi Kogyo Seiyaku Co., Ltd., 25% solution) | |
| (9) Ethanol water (ethanol content 59%) | 75 parts |

- Composition of polyvinyl alcohol solution -

| | |
|---|---|
| Polyvinyl alcohol | 20.3 parts |
| (trade name: “PVA235”, manufactured by | |
| Kuraray Co., Ltd., degree of saponification 88%, | |
| degree of polymerization 3500) | |
| Diethylene glycol monobutyl ether | 6.0 parts |
| (trade name: “BUTYCENOL 20P”, manufactured | |
| by Kyowa Hakko Chemicals Co., Ltd.) | |
| Ion-exchanged water | 263.7 parts |

(Preparation of basic solution B (second liquid))
A composition shown below was mixed under stirring,
and thus a basic solution B was obtained.

| | |
|---|---|
| (1) Boric acid | 0.65 parts |
| (2) Zirconyl ammonium carbonate | 2.5 parts |
| (trade name: ZIRCOSOL AC-7 (13% | |
| aqueous solution), manufactured by | |
| Daiichi Kigenso Kagaku Kogyo Co., Ltd.) | |
| (3) Ammonium carbonate | 4.0 parts |
| (first grade, manufactured by Kanto Chemical Co., Inc.) | |
| (4) Ion-exchanged water | 92.85 parts |
| (5) EMULGEN 109P | 0.6 parts |
| (polyoxyethylene lauryl ether, | |
| manufactured by Kao Corp.) | |

(Preparation of aqueous solution of
polyvalent metal salt C for in-line blend)
A composition shown below was mixed under stirring, and thus an
aqueous solution of polyvalent metal salt C for in-line blend was obtained.

| | |
|---|---|
| (1) ALFINE 83 | 20.0 parts |
| (polyaluminum chloride, manufactured by Taimei | |
| Chemicals Co., Ltd., 70% solution) | |
| (2) EMULGEN 109P | 4.4 parts |
| (polyoxyethylene lauryl ether, | |
| manufactured by Kao Corp.) | |
| (3) Ion-exchanged water | 75.6 parts |

(Preparation of Inkjet Recording Medium)

After performing a corona discharge treatment on the front surface of the support, a coating liquid A-2 for ink receiving layer was prepared by in-line mixing a flow of the coating liquid A for ink receiving layer (first liquid), which was flowed in an amount of coating of 173 g/m², with the aqueous solution of polyvalent metal salt C for in-line blend, at a rate of 10.8 g/m², and coating was carried out. Thereafter, the coating layer was dried using a hot air dryer at 80° C. (air speed 3 msec to 8 msec) until the solids content reached 20%. The coating layer exhibited constant rate drying pattern during the period. Thereafter, before the coating layer exhibited falling rate drying pattern, the coating layer was immersed in the basic solution B (second liquid) for 3 seconds to adhere the basic solution on the coating layer in an amount of 13 g/m², and the coating layer was dried at 80° C. for 10 minutes (curing process). Thereby, an inkjet recording medium provided with an ink receiving layer having a dry film thickness of 32 μm was produced.

[Measurement of Swelling Ratio of Water-Soluble Resin]

### (Preparation of Water-Soluble Resin Layer)

The surface of the support obtained as described above was subjected to a corona discharge treatment, and then a coating liquid for water-soluble resin layer shown below was applied on the surface using an extrusion die coater such that the film thickness after drying would be 5 μm. The coating layer was dried at 80° C. for 10 minutes, and thus a water-soluble resin layer was obtained.

(Coating liquid for water-soluble resin layer)

| | |
|---|---|
| Ion-exchanged water | 56.4 parts |
| Polyvinyl alcohol solution (7% aqueous solution) | 37.2 parts |
| (trade name: PVA235, manufactured by Kuraray Co., Ltd., | |
| degree of saponification 88%, degree of polymerization 3500) | |
| Boric acid (7.5% aqueous solution) | 6.4 parts |
| EMULGEN 109P (10% aqueous solution) | 0.7 parts |
| (Polyoxyethylene lauryl ether, manufactured by Kao Corp.) | |

(Measurement of Swelling Ratio)

The water-soluble resin layer was conditioned for two days under an environment of 23° C. and 50% RH, and then the swelling ratio of the water-soluble resin layer was measured under the same environment, 5 minutes after adding dropwise 1 mL of the water-soluble organic solvent described in Table 1, based on the changes in the film thickness. When the water-soluble resin was PVA235, and the water-soluble organic solvent was diethylene glycol monomethyl ether, the swelling ratio of the resin was 0.9% (other combinations of the water-soluble resin/water-soluble organic solvent were also measured by substantially the same method).

<Preparation of Ink>

(Preparation of Magenta Ink)

Deionized water was added to the following components to obtain a final volume of 1 liter, and then the mixture was stirred for one hour while the mixture was heated at 30° C. to 40° C. Subsequently, the mixture was adjusted to pH 9 using 10 mol/L of KOH, and the mixture was filtered under reduced pressure through a microfilter having an average pore size of 0.25 μm, to thus prepare a magenta ink liquid (M-101).

| | | |
|---|---|---|
| Dye M-1 described below | 35.0 | g/L |
| Triethylene glycol (swelling ratio for PVA235: 5.0%) | 19.0 | g/L |
| Diethylene glycol monomethyl ether (DEGmME) | 100.0 | g/L |
| (swelling ratio for PVA235: 0.9%) | | |
| 2-Pyrrolidone (swelling ratio for PVA235: 4.5%) | 11.0 | g/L |
| Urea | 24.0 | g/L |
| PROXEL XL2 (manufactured by Avecia Biologics, Ltd.) | 1.1 | g/L |
| Betaine compound described below | 17.0 | g/L |
| SC-P400 (POP (4) diglyceryl ether) | 100.0 | g/L |

M-1

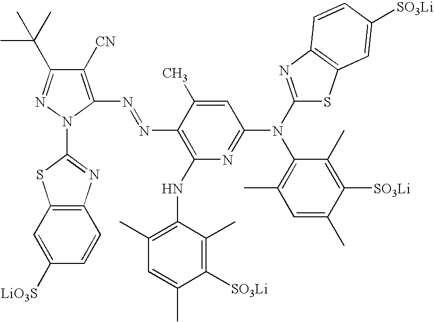

Betaine compound

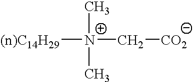

<Performance Evaluation>

[Density]

Using a printer (trade name: A820, manufactured by Seiko Epson Corp.), a magenta solid image was printed, using the magenta ink obtained as described above, on the side having the ink receiving layer of the inkjet recording medium obtained as described above, under an environment of 25° C. and 50% RH and under the setting of no color correction. The printed image was stored in the same environment for 24 hours. After the storage, density measurement was carried out with X-RITE 310 (trade name, manufactured by X-Rite, Inc.), and the image was evaluated according to the following evaluation criteria. The obtained results are shown in Table 1.

A: Having a density of 2.4 or more

B: Having a density of 2.3 or more but less than 2.4

C: Having a density of 2.2 or more but less than 2.3

D: Having a density of less than 2.2

[Color Change from Immediately after Printing]

Printing of magenta solid image was carried out on the side having the inkjet receiving layer of the inkjet recording medium obtained as described above, using a printer (trade name: A820, manufactured by Seiko Epson Corp.) under an environment of 23° C. and 50% RH.

Immediately after the printing (within 2 minutes after printing) and after a lapse of 24 hours from the printing, the colors of the respective magenta solid parts were measured, and the difference between the color immediately after the printing and the color after a lapse of 24 hours from the printing, was designated as color difference (ΔE).

Here, the measurement of color was carried out by measuring L*a*b* under the conditions of light source F8 and at a viewing angle of 2 degree, using a spectrophotometer (trade name: SPECTROLINO, manufactured by GretagMacbeth, Inc.)

Color change was evaluated from the obtained color difference (ΔE) according to the following evaluation criteria. The obtained results are shown in Table 1.

—Evaluation Criteria—

A . . . ΔE<1: Color change is almost unrecognizable.

B . . . 1≦ΔE<2: Color change is recognizable but not quite visible.

C . . . 2≦ΔE<4: Color change is fairly visible.

D . . . 4≦ΔE: Color change is at a large level of causing a problem.

[Ejectability]

Ejection stability of the inkjet ink prepared as described above was evaluated as follows. The evaluation environment was at a temperature of 25° C. and a relative humidity of 50%.

As an apparatus for evaluation, DIMATIX MATERIAL PRINTER DMP-2831 (manufactured by Fujifilm Dimatix, Inc.) mounted with a DIMATIX MATERIAL CARTRIDGE DMC-11610 (10 pL) (manufactured by Fujifilm Dimatix, Inc.) was used, and evaluation was performed for the following evaluation items (i) to (iii). The results were evaluated according to the following evaluation criteria. Image irregularities were observed by visual inspection using an optical microscope. Ejection ratio was calculated by “(number of nozzles recognized of ejection/total number of nozzles)×100(%)”. The results are shown in Table 1.

The ink cartridge was modified to have a liquid loading volume of 100 mL.

—Evaluation Items—

(i) The state in which image irregularities are not visible is designated as good.

(ii) The state in which the ejection ratio obtained at the time of re-ejection after continuous ejection for one minute and subsequent standing for 30 minutes while uncapped, is 90% or more (non-ejection ratio being less than 10%), is designated as good.

(iii) The state in which the ejection ratio after continuous ejection for 60 minutes is 90% or more (non-ejection ratio being less than 10%), is designated as good.

—Evaluation Criteria—

AA: All of (i) to (iii) are satisfied.

A: Two items, (i) and (ii), are satisfied.

B: Two items, (i) and (iii), are satisfied.

C: Only (i) is satisfied.

D: All of (i) to (iii) are not satisfied.

### Examples 2 to 16 and Comparative Examples 1 to 4

Magenta inks were prepared in a manner substantially similar to the process in the preparation of the magenta ink (M-101) of Example 1, except that the water-soluble organic solvent, the type and amount of the diglycerin derivative, and the like used in Example 1 were changed as indicated in the following table. Image printing was performed in a manner substantially similar to that in Example 1, and the printed images were evaluated in a manner substantially similar to that in Example 1. The obtained results are shown in the following table.

The swelling ratio of TEGmME for the water-soluble resin was 3.4%. In the Examples and Comparative Examples, DPGmBE represents dipropylene glycol monobutyl ether, PGmME represents propylene glycol monomethyl ether, and TEGmME represents triethylene glycol monomethly ether.

TABLE 1

| | | | | Specific water-soluble organic solvent (a) | | | |
|---|---|---|---|---|---|---|---|
| | | | | | | Swelling | |
| | | General solvent (b) | | | | ratio (for | |
| | Total amount | | Content | | Content | water- | Content |
| | of solvent | Name of | (relative | Name of | (relative | soluble | ratio |
| | (a + b) | solvent | to ink) | solvent | to ink) | resin) | (a)/(a + b) |
| Example 1 | 13.0% | TEG/2-Py | 3.0% | DEGmME | 10% | 0.9% | 77% |
| Example 2 | 13.0% | TEG/2-Py | 3.0% | DEGmME | 10% | 0.9% | 77% |
| Example 3 | 13.0% | TEG/2-Py | 3.0% | DEGmME | 10% | 0.9% | 77% |
| Example 4 | 13.0% | TEG/2-Py | 3.0% | DEGmME | 10% | 0.9% | 77% |
| Example 5 | 13.0% | TEG/2-Py | 3.0% | DEGmME | 10% | 0.9% | 77% |
| Example 6 | 13.0% | TEG/2-Py | 3.0% | DEGmME | 10% | 0.9% | 77% |
| Example 7 | 13.0% | TEG/2-Py | 3.0% | DEGmME | 10% | 0.9% | 77% |
| Example 8 | 13.0% | TEG/2-Py | 3.0% | DEGmME | 10% | 0.9% | 77% |
| Example 9 | 13.0% | TEG/2-Py | 3.0% | DEGmME | 10% | 0.9% | 77% |
| Example 10 | 18.0% | TEG/2-Py | 3.0% | DEGmME | 10% | 0.9% | 56% |
| Example 11 | 13.0% | TEG/2-Py | 3.0% | DPGmBE | 10% | 0.9% | 77% |
| Example 12 | 13.0% | TEG/2-Py | 3.0% | 1,2- | 10% | 2.0% | 77% |
| | | | | Hexanediol | | | |
| Example 13 | 13.0% | TEG/2-Py | 3.0% | PGmME | 10% | 0.4% | 77% |
| Example 14 | 18.0% | TEG/2-Py | 8.0% | DEGmME | 10% | 0.9% | 56% |
| Example 15 | 13.0% | TEG/2-Py | 3.0% | DEGmME | 10% | 0.9% | 77% |
| Example 16 | 13.0% | TEG/2-Py | 3.0% | DEGmME | 10% | 0.9% | 77% |
| Comparative | 23.0% | TEG/2-Py | 3.0% | DEGmME | 10% | 0.9% | 43% |
| Example 1 | | | | | | | |
| Comparative | 13.0% | TEG/2-Py | 3.0% | DEGmME | 10% | 0.9% | 77% |
| Example 2 | | | | | | | |
| Comparative | 13.0% | TEG/2-Py | 3.0% | no addition | — | — | 0% |
| Example 3 | | TEGmME | 10% | | | | |
| Comparative | 23.0% | TEG/2-Py | 3.0% | DEGmME | 10% | 0.9% | 43% |
| Example 4 | | | | | | | |

| | Diglycerin derivative | | | | | |
|---|---|---|---|---|---|---|
| | | | Amount | | | |
| | | | of | | | |
| | | Average | addition | Evaluation | | |
| | Name of | molecular | (relative | | Color | |
| | product | weight | to ink) | Density | change | Ejectability |
| Example 1 | SC-P400 | 400 | 10% | A | A | AA |
| Example 2 | SC-P750 | 750 | 10% | A | A | AA |
| Example 3 | SC-P1000 | 1000 | 10% | A | A | A |
| Example 4 | SC-P1200 | 1200 | 10% | A | A | A |
| Example 5 | SC-P1600 | 1600 | 10% | A | A | A |
| Example 6 | SC-E750 | 750 | 10% | A | A | A |
| Example 7 | SC-E1500 | 1500 | 10% | A | A | A |
| Example 8 | SC-E2000 | 2000 | 10% | A | A | A |
| Example 9 | SC-P750 | 750 | 5% | A | A | A |
| Example 10 | Glycerin/SC- | 92/400 | 5%/5% | A | B | AA |
| | P400 | | | | | |
| Example 11 | SC-P750 | 750 | 10% | A | A | AA |
| Example 12 | SC-P750 | 750 | 10% | A | B | A |
| Example 13 | SC-P750 | 750 | 10% | A | A | AA |
| Example 14 | SC-P750 | 750 | 10% | A | B | AA |
| Example 15 | SC-P400 | 400 | 20% | A | A | A |
| Example 16 | SC-P750 | 750 | 20% | A | A | B |
| Comparative | Glycerin | 92 | 10% | B | D | A |
| Example 1 | | | | | | |
| Comparative | no addition | — | 0% | A | A | D |
| Example 2 | | | | | | |
| Comparative | SC-P750 | 750 | 10% | B | C | AA |
| Example 3 | | | | | | |
| Comparative | Diglycerin | 166 | 10% | C | C | AA |
| Example 4 | | | | | | |

General solvent: Refers to the water-soluble organic solvent other than the specific water-soluble organic solvent.
The details of the diglycerin derivative in the table are as follows.
SC-P750: POP (9) diglyceryl ether (manufactured by Sakamoto Yakuhin Kogyo Co., Ltd.)
SC-P1000: POP (14) diglyceryl ether (manufactured by Sakamoto Yakuhin Kogyo Co., Ltd.)
SC-P1200: POP (18) diglyceryl ether (manufactured by Sakamoto Yakuhin Kogyo Co., Ltd.)
SC-P1600: POP (24) diglyceryl ether (manufactured by Sakamoto Yakuhin Kogyo Co., Ltd.)
SC-E750: POE (13) diglyceryl ether (manufactured by Sakamoto Yakuhin Kogyo Co., Ltd.)
SC-E1500: POE (30) diglyceryl ether (manufactured by Sakamoto Yakuhin Kogyo Co., Ltd.)
SC-E2000: POE (40) diglyceryl ether (manufactured by Sakamoto Yakuhin Kogyo Co., Ltd.)

As it is obvious from the table above, Examples which use the inks of the invention show inkjet recording methods capable of obtaining sharp and high-density recorded images, capable of highly suppressing color changes from immediately after printing, and having excellent ejection stability.

What is claimed is:

1. An inkjet recording method comprising performing recording on an inkjet recording medium having a support and an ink receiving layer containing at least inorganic microparticles, a water-soluble resin and a crosslinking agent provided on the support, using an inkjet ink containing at least a dye, water, a diglycerin derivative represented by the following formula (1) and a water-soluble organic solvent, wherein 40% by weight or more of the water-soluble organic solvent is a water-soluble organic solvent which gives a swelling ratio of 3% or less for the water-soluble resin that has been crosslinked by the crosslinking agent: 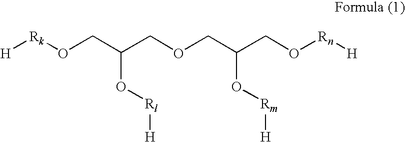
wherein R represents an alkyleneoxy group having 2 to 5 carbon atoms; k, l, m and n each represent an integer indicating the number of repetition of the alkyleneoxy group; and k+l+m+n=0 to 50.

2. The inkjet recording method of claim 1, wherein the total content of the water-soluble organic solvent is 5% by weight to 25% by weight relative to the total weight of the inkjet ink.

3. The inkjet recording method of claim 1, wherein the content of the diglycerin derivative represented by formula (1) is 2% by weight to 15% by weight relative to the total weight of the inkjet ink.

4. The inkjet recording method of claim 1, wherein the total content of the water-soluble organic solvent is 5% by weight to 25% by weight relative to the total weight of the inkjet ink, and the content of the diglycerin derivative represented by formula (1) is 2% by weight to 15% by weight relative to the total weight of the inkjet ink.

5. The inkjet recording method of claim 1, wherein the water-soluble organic solvent (B) which gives the swelling ratio of 3% or less is at least one selected from the group consisting of 1,2-alkanediol, ethylene glycol monoalkyl ether, diethylene glycol monoalkyl ether, propylene glycol monoalkyl ether, dipropylene glycol monoalkyl ether, ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether.

6. The inkjet recording method of claim 1, wherein the content of the water-soluble organic solvent which gives the swelling ratio of 3% or less is 60% by weight or more relative to the water-soluble organic solvent.

7. The inkjet recording method of claim 1, wherein the total content of the water-soluble organic solvent is 5% by weight to 25% by weight relative to the total weight of the inkjet ink, the content of the diglycerin derivative represented by formula (1) is 2% by weight to 15% by weight relative to the total weight of the inkjet ink, and the content of the water-soluble organic solvent which gives the swelling ratio of 3% or less is 60% by weight or more relative to the water-soluble organic solvent.
